(19) United States
(12) Patent Application Publication
(10) Pub. No.: US 2026/0073437 A1
(43) Pub. Date: Mar. 12, 2026

(54) Information Processing Method, Non-Transitory Computer-Readable Storage Medium, and Information Processing Device

(71) Applicant: NeCLEAR LLC, Yaeyama-gun, Okinawa (JP)

(72) Inventor: Daiki Nakayama, Yaeyama-gun, Okinawa (JP)

(21) Appl. No.: 19/108,686

(22) PCT Filed: Sep. 6, 2023
(86) PCT No.: PCT/JP2023/032479

§ 371 Date: Mar. 4, 2025

(30) Foreign Application Priority Data
Sep. 8, 2022 (JP) 2022-143181

(51) Int. Cl. G06Q 30/0601; G06F 16/955

(52) U.S. Cl. CPC G06Q 30/0619; G06F 16/955

(57) ABSTRACT

An information processing method according to one aspect is characterized in that a plurality of service providers who provide services are registered, business information indicating the details of business is output to a terminal device (3) of each registered service provider, a service provider with whom an order for the business is to be placed, among the service providers, is specified in a single auction format on a first-come, first-served basis in relation to the business information, and a process for paying a predetermined referral fee from the specified service provider to an orderer who places an order for the business is executed.

### REFERENCE TO RELATED APPLICATIONS

This application is the national phase under 35 U.S.C. § 371 of PCT International Application No. PCT/JP2023/032479 which has International filing date of Sep. 6, 2023 and designated the United States of America, and claiming priority on Patent application No.2022-143181 filed in Japan on Sep. 8, 2022.

### BACKGROUND ART

In recent years, the development of order placing and receiving technology for business has progressed. For example, Japanese Patent Application Laid-Open No. 2019-003232 discloses an order placing and receiving system for travel products that performs order placing and receiving processing for travel products and travel services involving tour conductors in response to requests from user terminals and tour conductor terminals connected through a network.

### DESCRIPTION

However, the invention according to Japanese Patent Application Laid-Open No. 2019-003232 has a problem in that it is not possible to perform order placing and receiving processing between service providers.

An object of one aspect is to provide an information processing method and the like that enable order placing and receiving processing between service providers.

An information processing method according to one aspect is characterized in that a plurality of service providers who provide services are registered, business information indicating the details of business is output to a terminal device of each registered service provider, a service provider with whom an order for the business is to be placed, among the service providers, is specified in a single auction format on a first-come, first-served basis in relation to the business information, and a process of paying a predetermined referral fee from the specified service provider to an orderer who places an order for the business is executed.

According to one aspect, it becomes possible to perform order placing and receiving processing between service providers.

The above and further objects and features will more fully be apparent from the following detailed description with accompanying drawings.

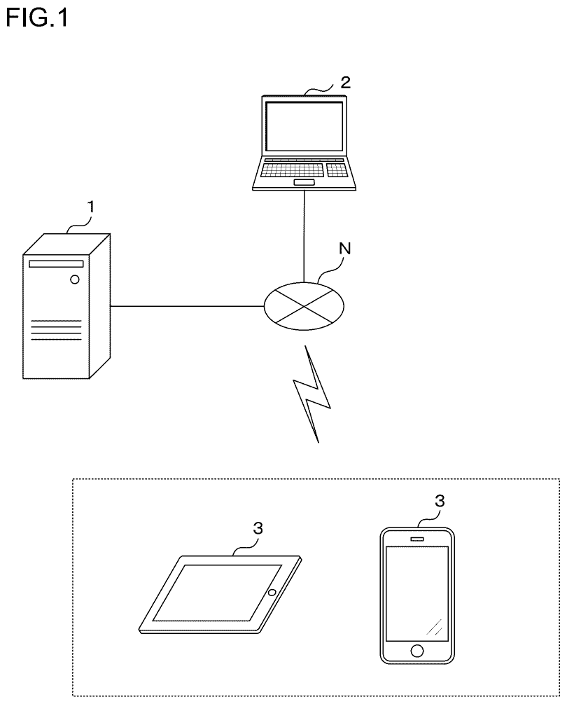

FIG. 1 is an explanatory diagram showing the outline of an order placing and receiving system.

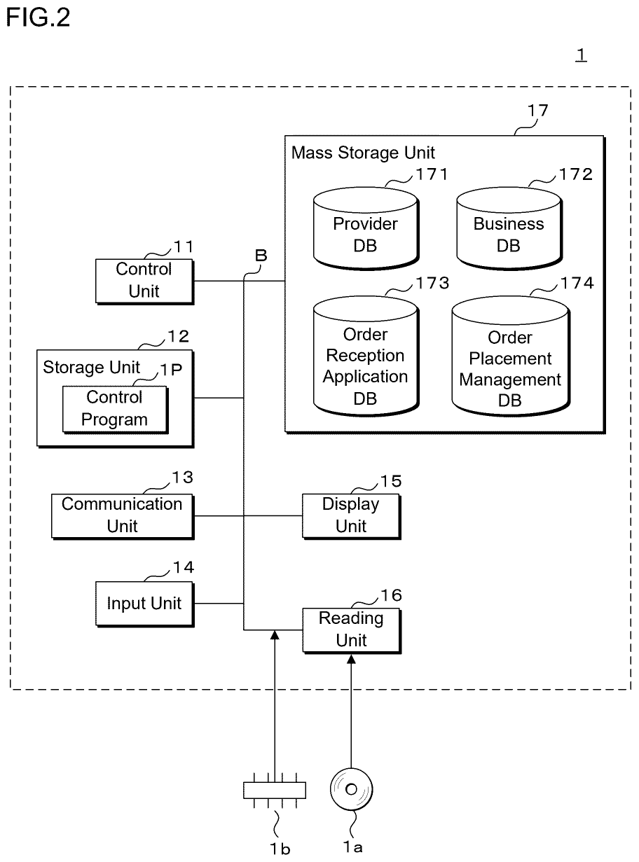

FIG. 2 is a block diagram showing a configuration example of a server.

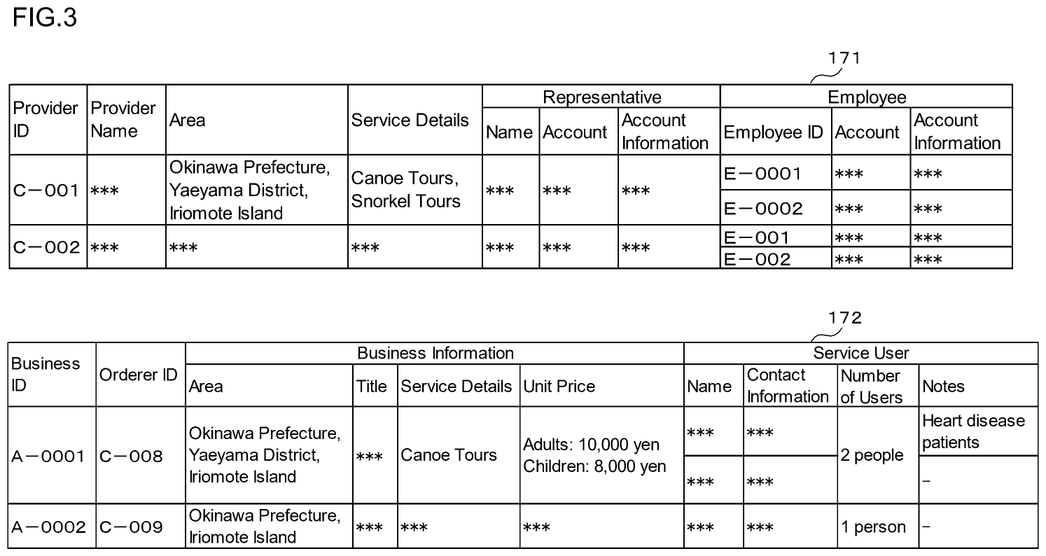

FIG. 3 is an explanatory diagram showing an example of a record layout of each of a provider DB and a service DB.

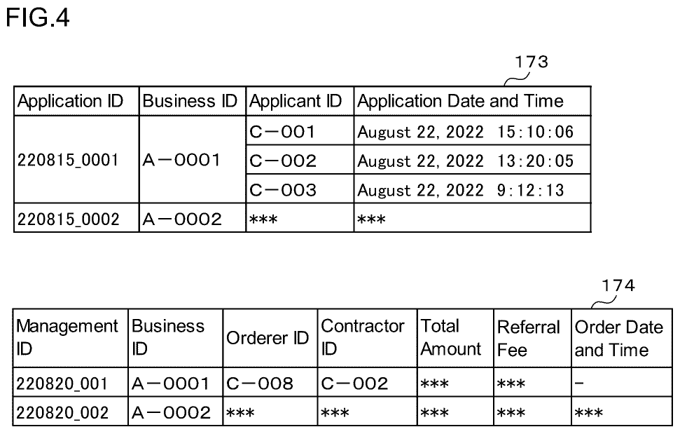

FIG. 4 is an explanatory diagram showing an example of a record layout of each of an order reception application DB and an order placement management DB.

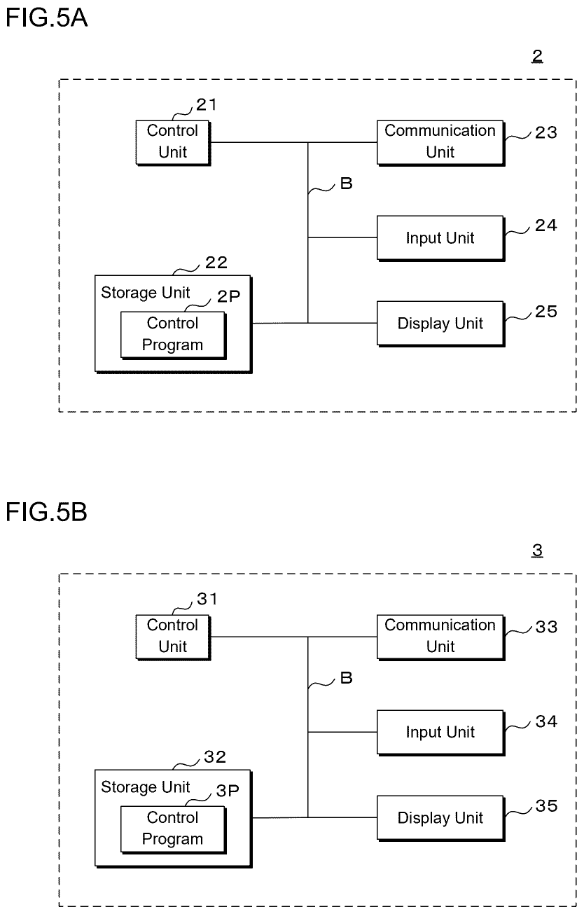

FIG. 5A is a block diagram showing a configuration example of an orderer terminal.

FIG. 5B is a block diagram showing a configuration example of a provider terminal.

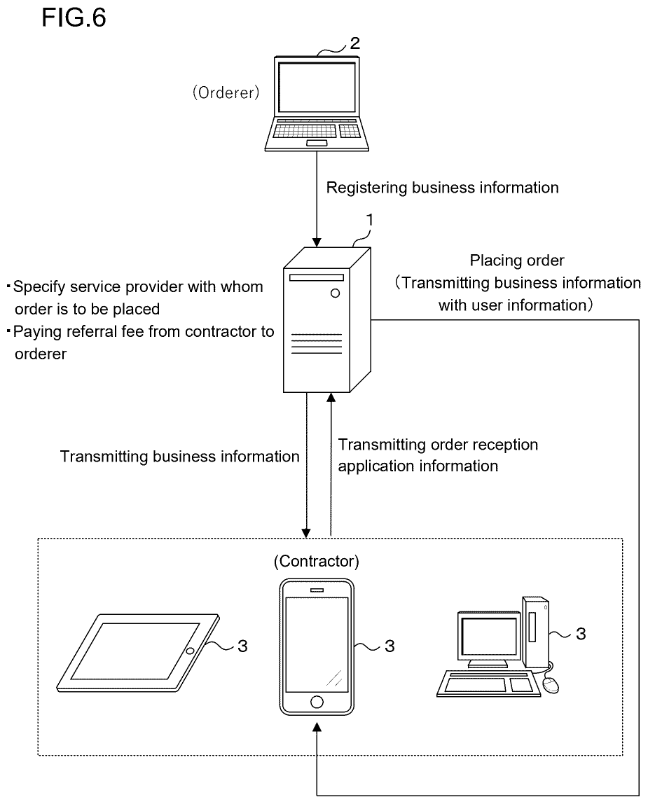

FIG. 6 is an explanatory diagram for explaining the processing operation of the order placing and receiving system.

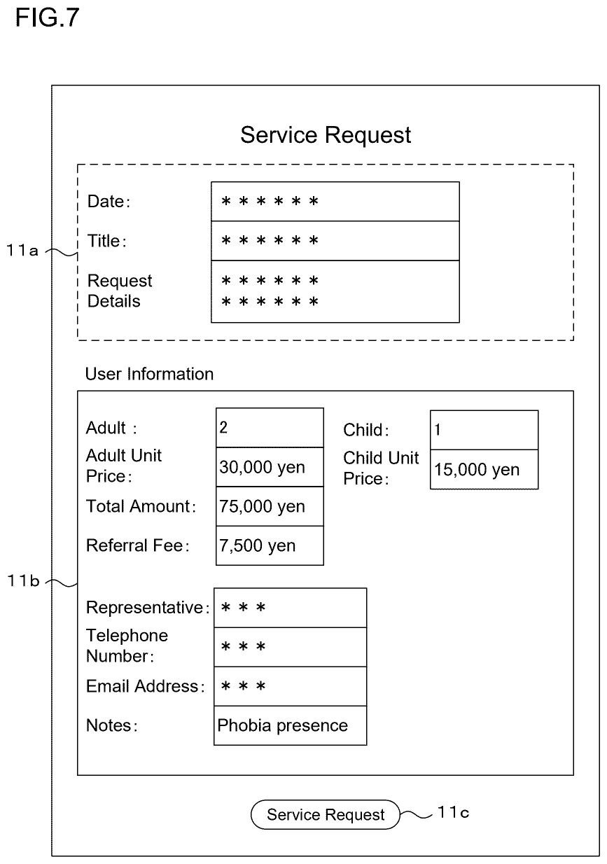

FIG. 7 is an explanatory diagram showing an example of a display screen for placing an order (making a request).

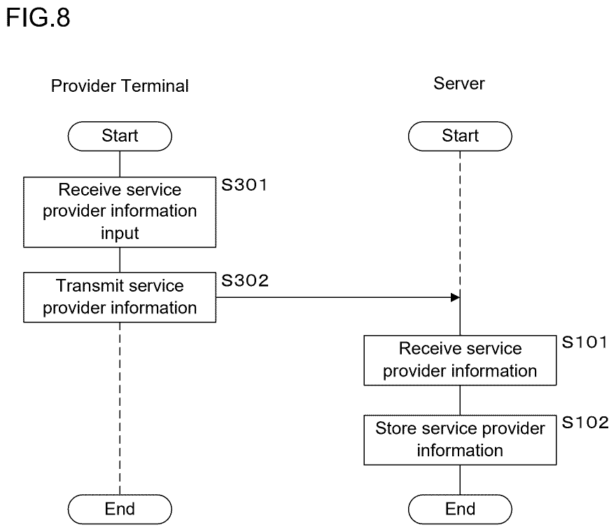

FIG. 8 is a flowchart showing the procedure of a process when registering service provider information.

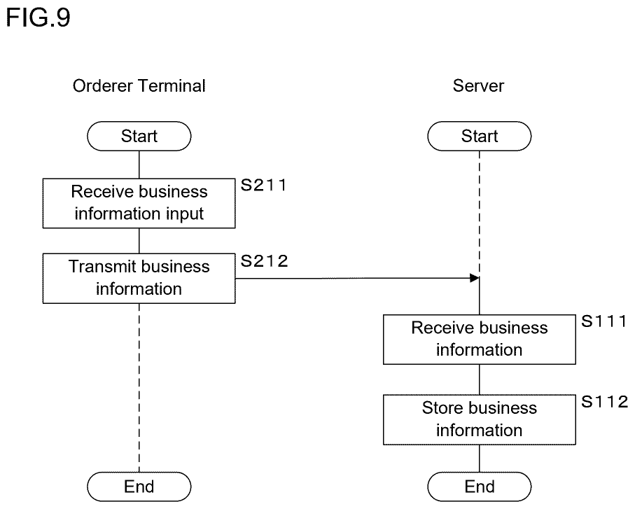

FIG. 9 is a flowchart showing the procedure of a process when registering business information.

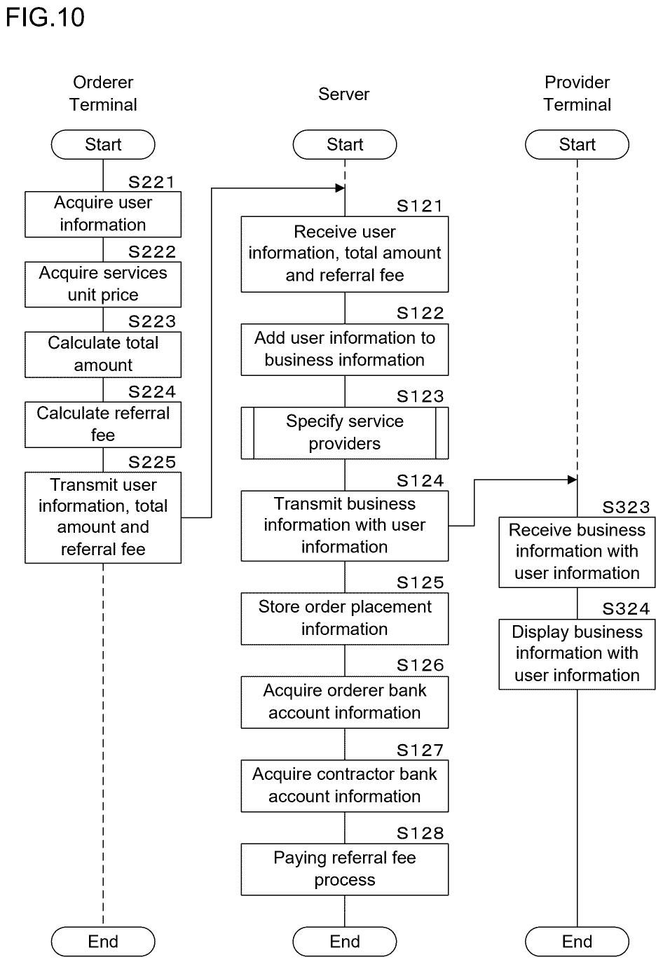

FIG. 10 is a flowchart showing the procedure of a process when placing an order with a service provider.

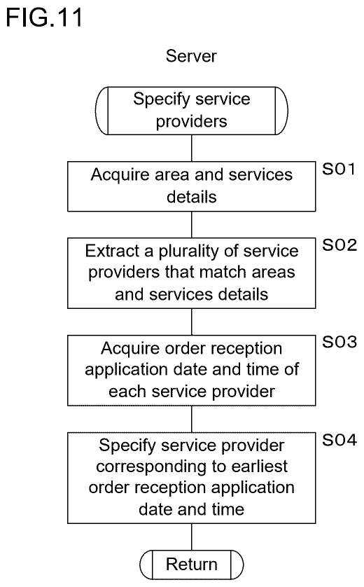

FIG. 11 is a flowchart showing the processing procedure of a subroutine for a process of specifying service providers with whom orders can be placed.

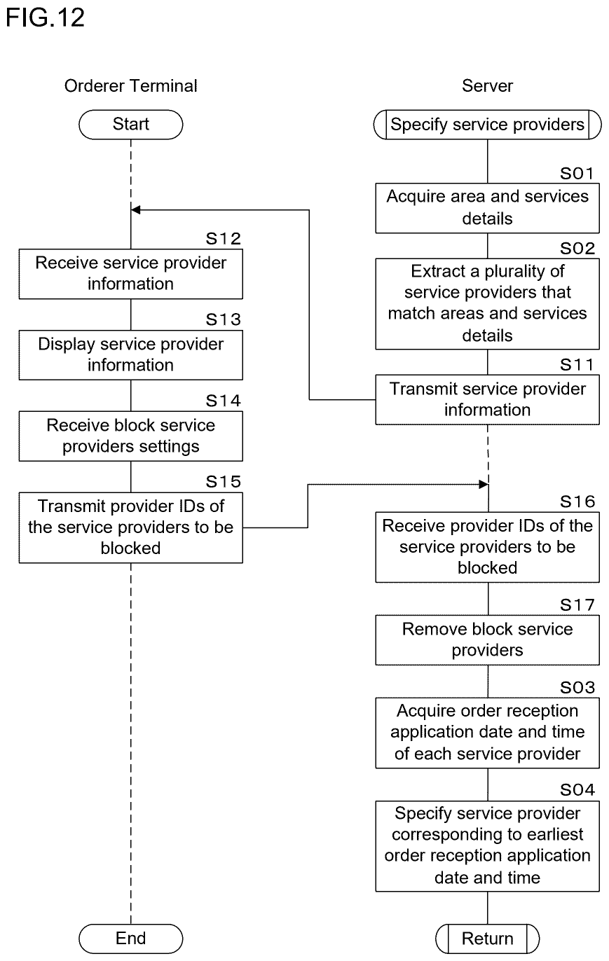

FIG. 12 is a flowchart showing the processing procedure of a subroutine for a process of specifying service providers with whom orders can be placed in Modification Example 1.

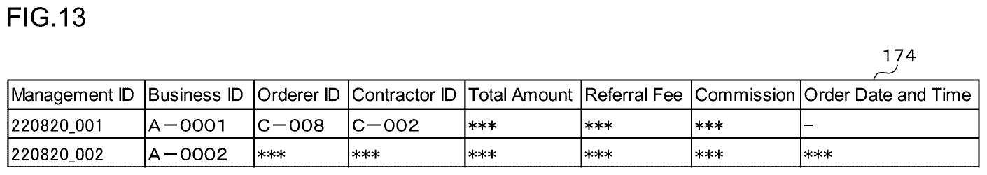

FIG. 13 is an explanatory diagram showing an example of a record layout of an order placement management DB 174 in Embodiment 2.

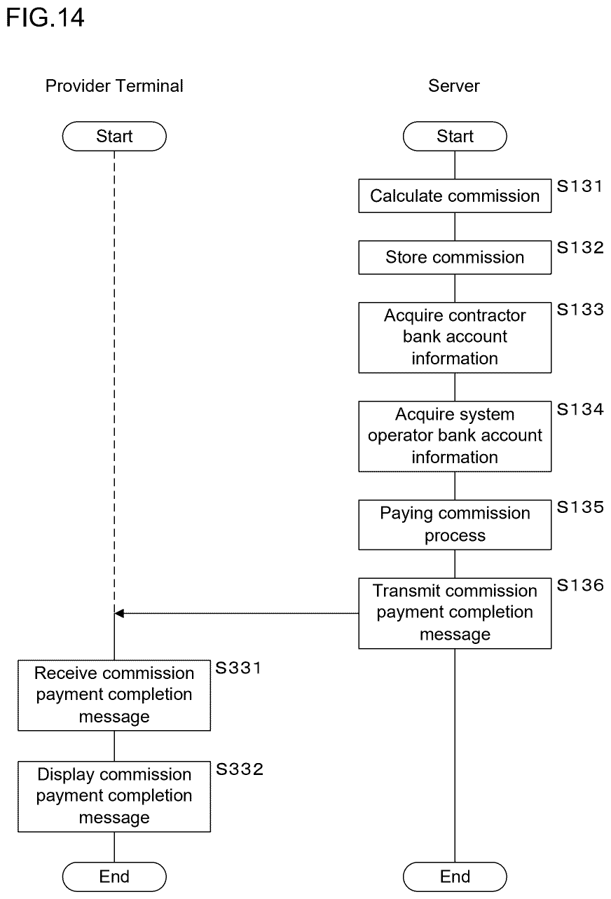

FIG. 14 is a flowchart showing the procedure of a process when paying a commission from a service provider to a system operator.

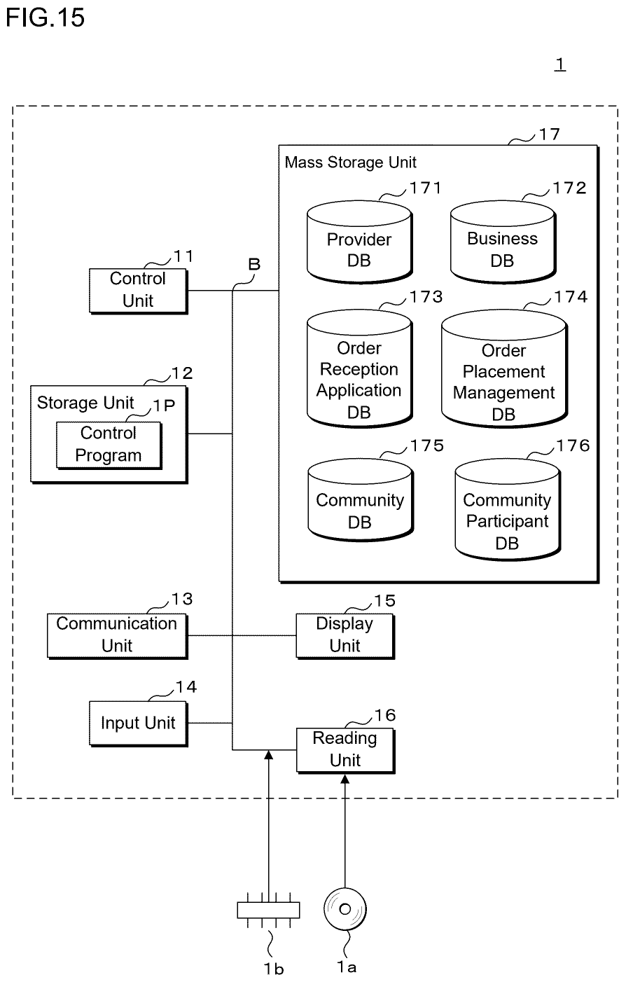

FIG. 15 is a block diagram showing a configuration example of a server in Embodiment 3.

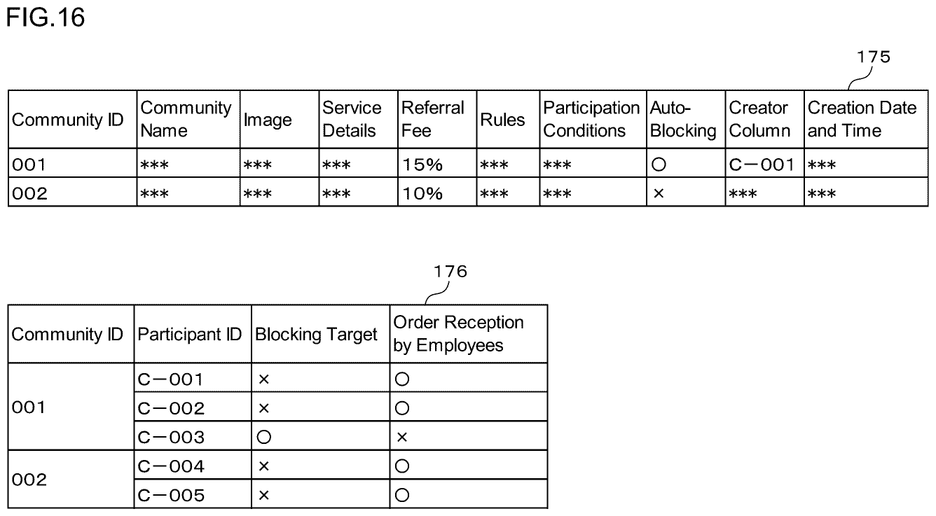

FIG. 16 is an explanatory diagram showing an example of a record layout of each of a community DB and a community participant DB.

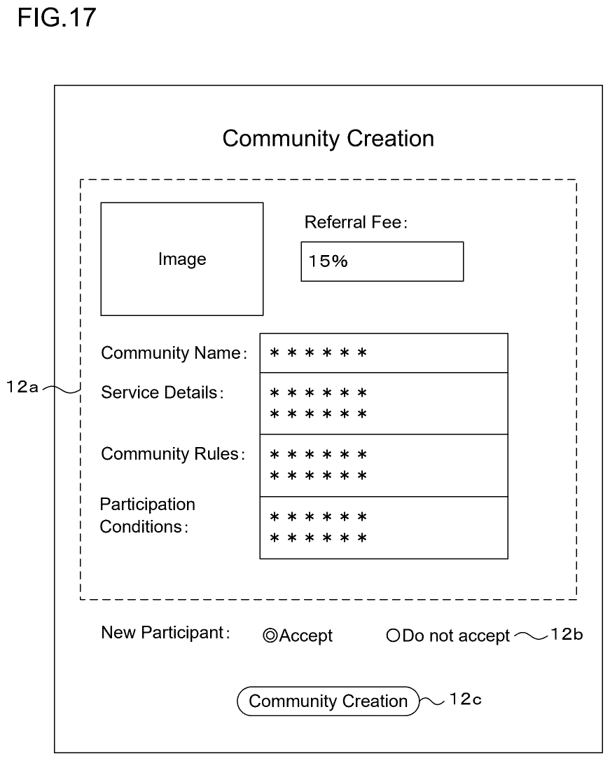

FIG. 17 is an explanatory diagram showing an example of a community creation screen.

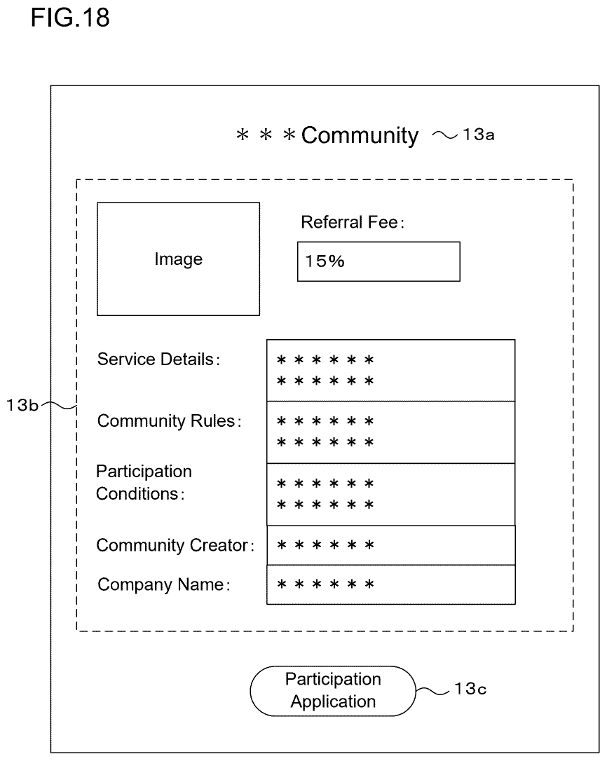

FIG. 18 is an explanatory diagram showing an example of a screen for receiving a request to participate in a community.

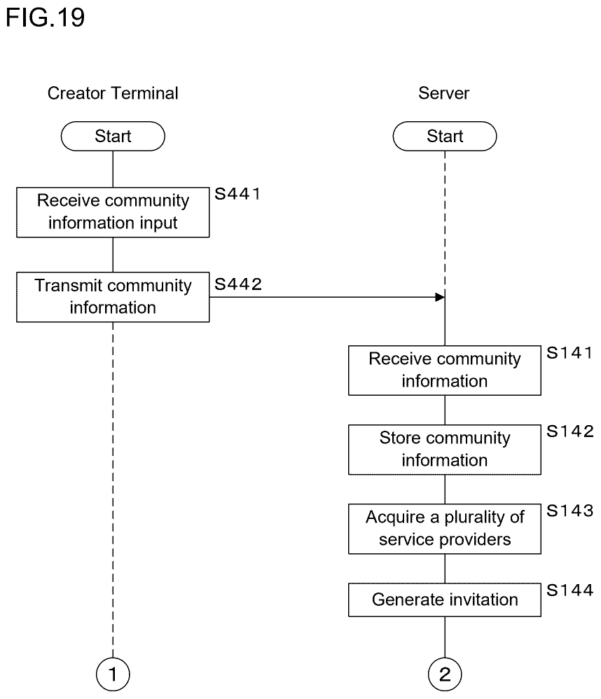

FIG. 19 is a flowchart showing the procedure of a process when receiving a request to participate in a community.

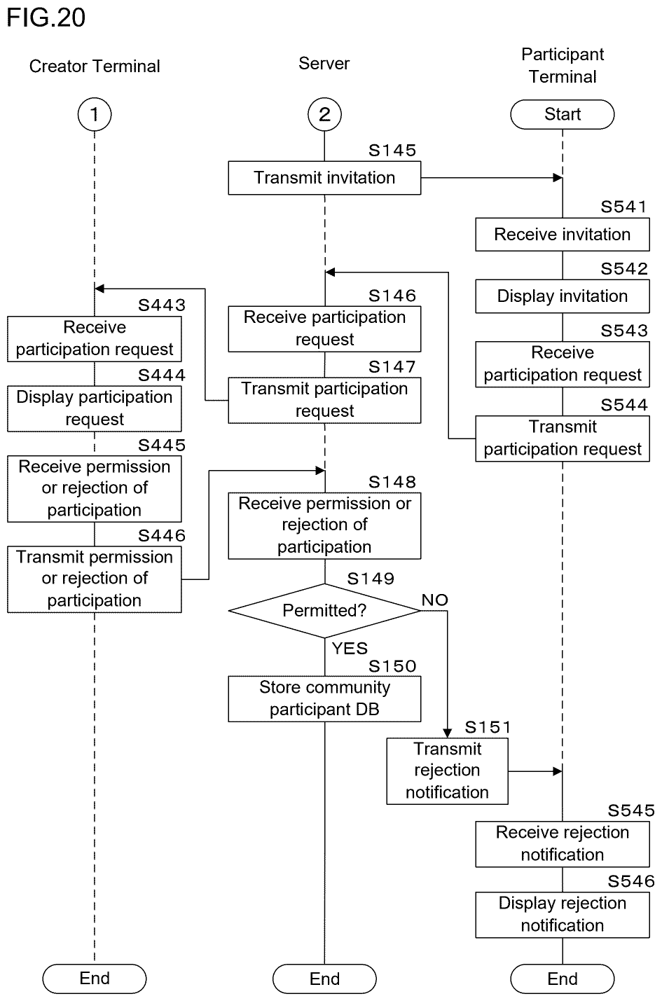

FIG. 20 is a flowchart showing the procedure of a process when receiving a request to participate in a community.

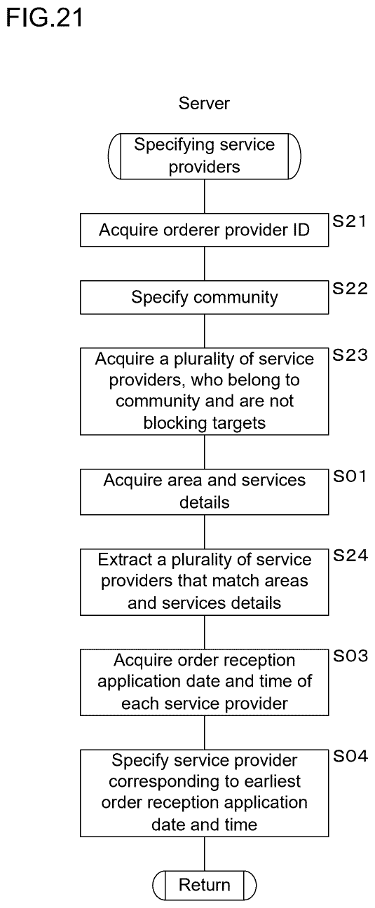

FIG. 21 is a flowchart showing the processing procedure of a subroutine for a process of specifying service providers with whom orders can be placed in Embodiment 3.

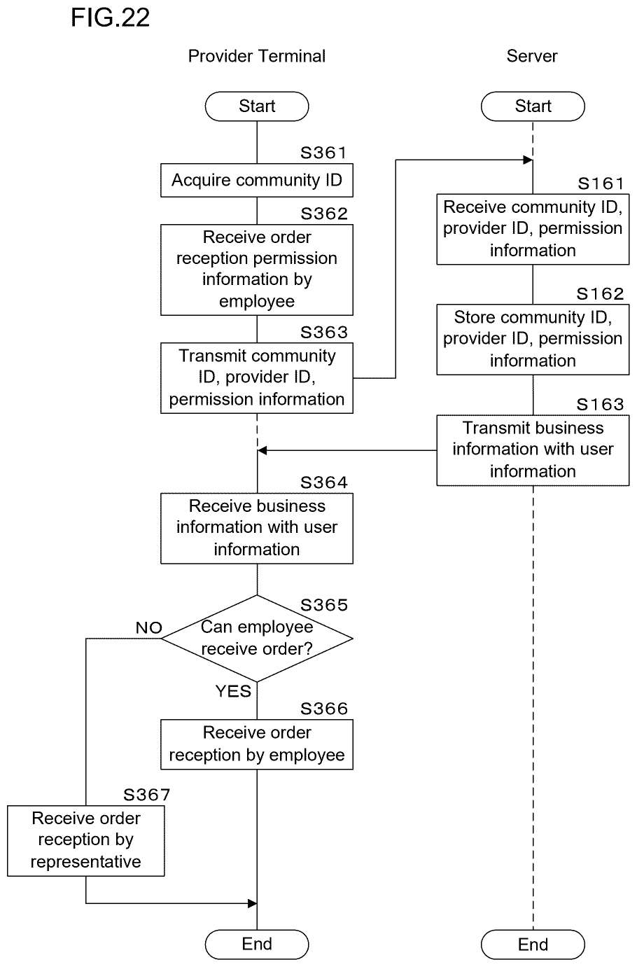

FIG. 22 is a flowchart showing the procedure of a process when receiving an order by an employee.

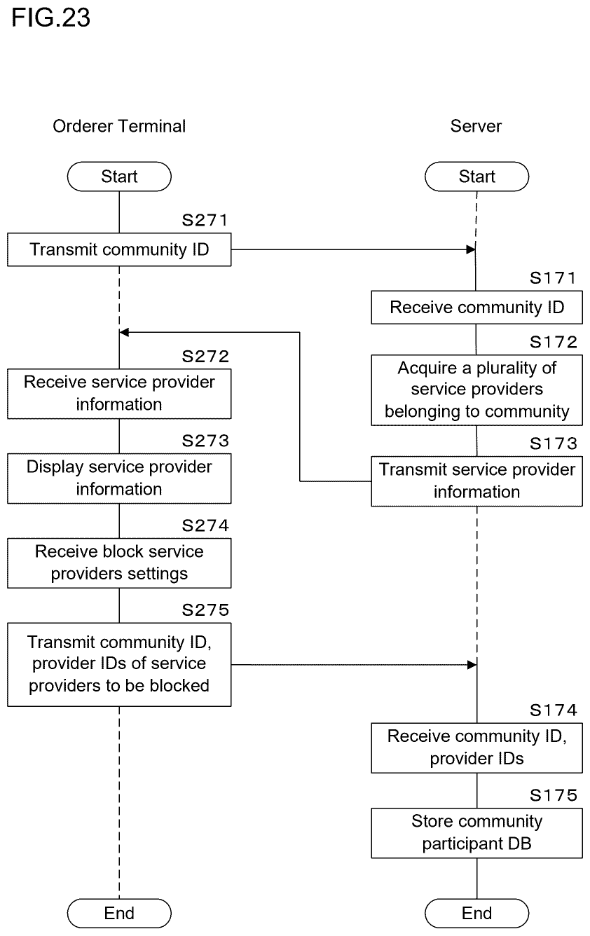

FIG. 23 is a flowchart showing the procedure of a process when receiving the settings of service providers to be blocked.

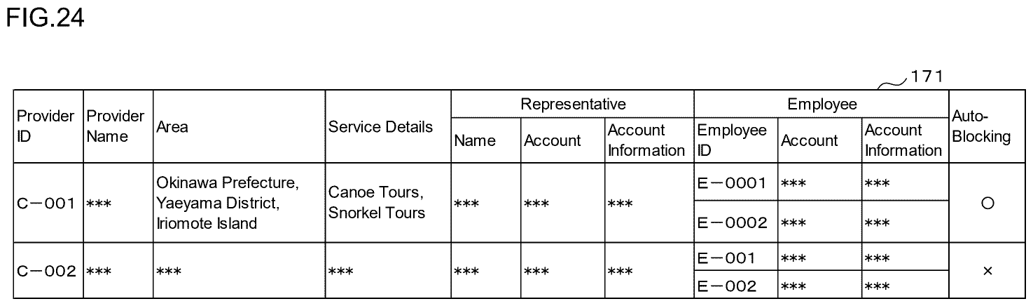

FIG. 24 is an explanatory diagram showing an example of a record layout of a provider DB in Embodiment 5.

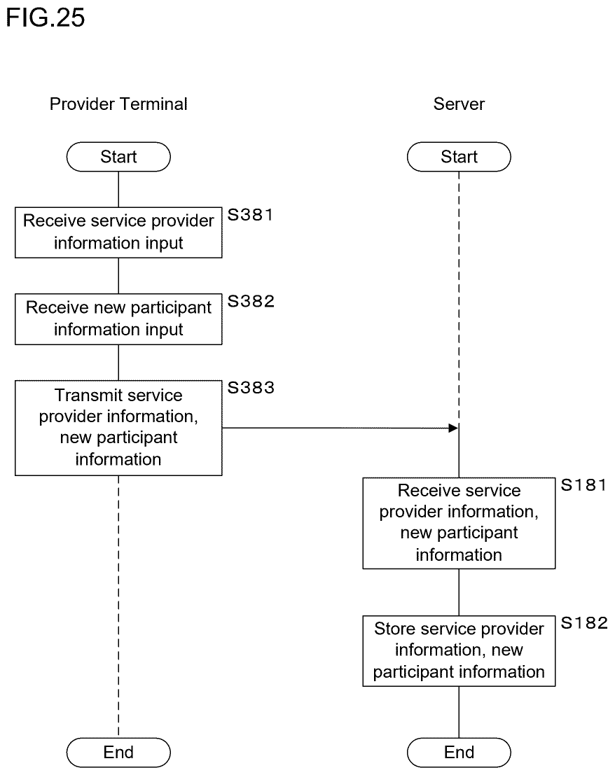

FIG. 25 is a flowchart showing the procedure of a process when registering service provider information in Embodiment 5.

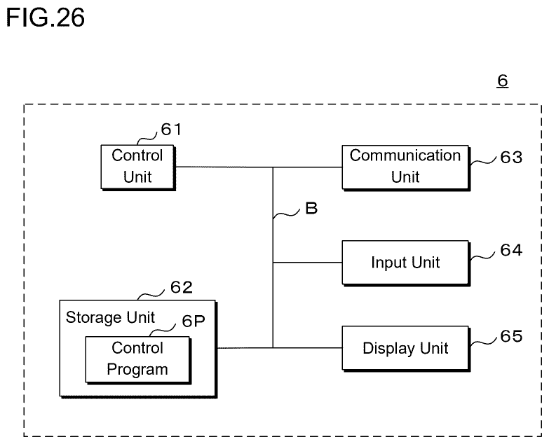

FIG. 26 is a block diagram showing a configuration example of a user terminal.

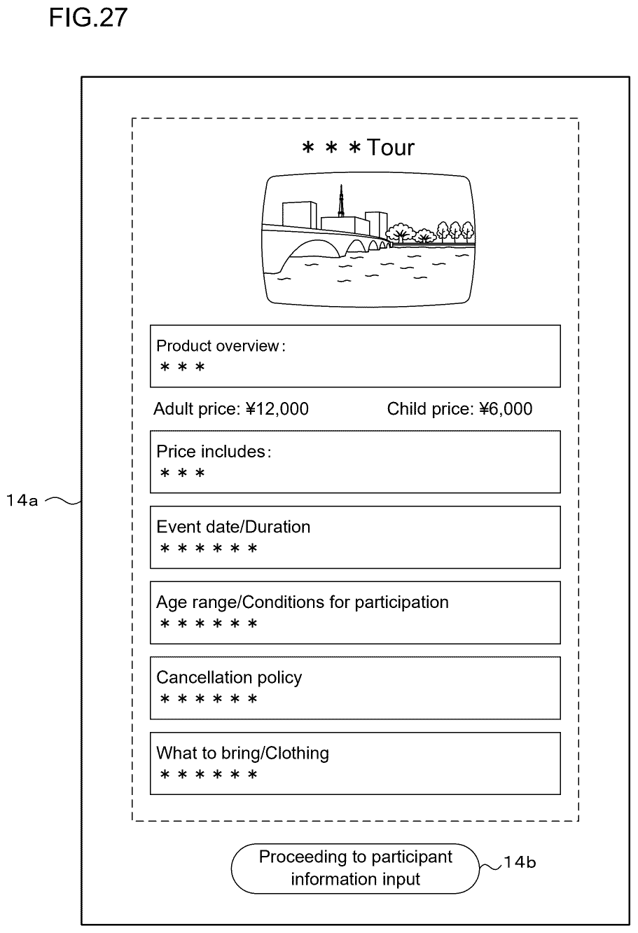

FIG. 27 is an explanatory diagram showing an example of a service introduction Web page (screen).

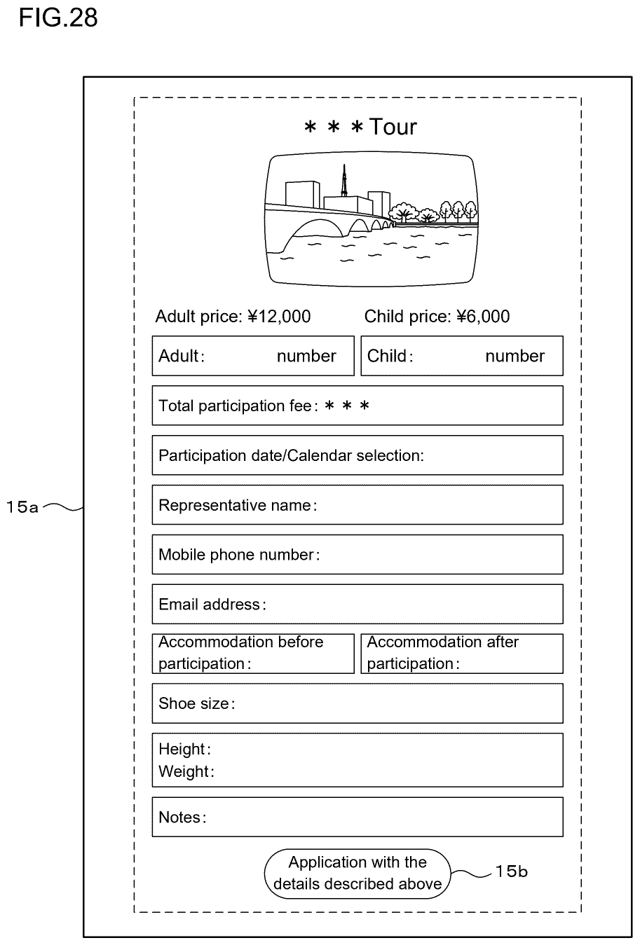

FIG. 28 is an explanatory diagram showing an example of a user information input Web page (screen).

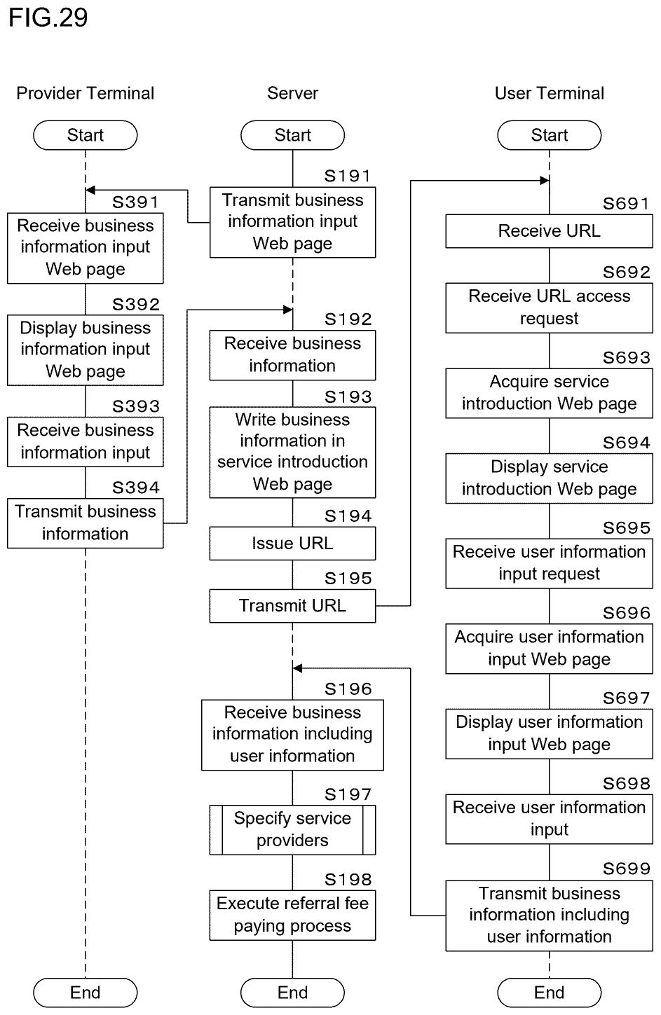

FIG. 29 is a flowchart showing the procedure of a process when introducing a user to each service provider.

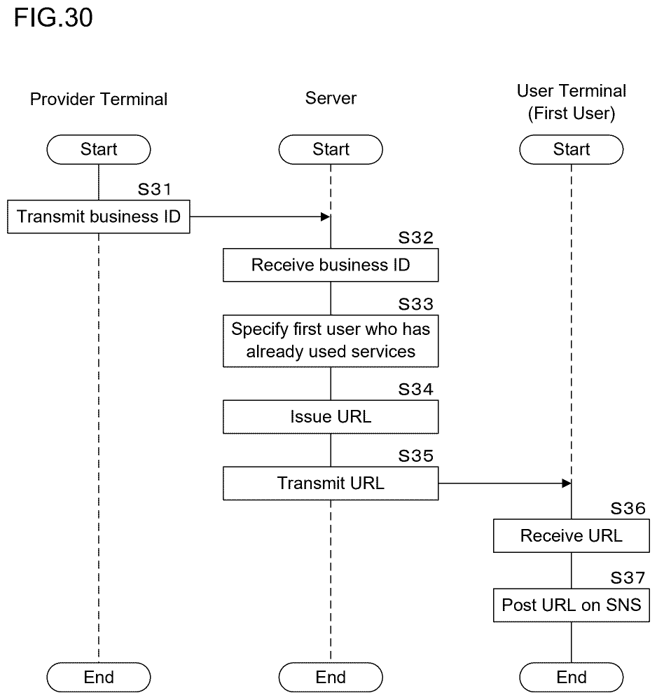

FIG. 30 is a flowchart showing the procedure of a process when issuing a URL to access a service introduction Web page.

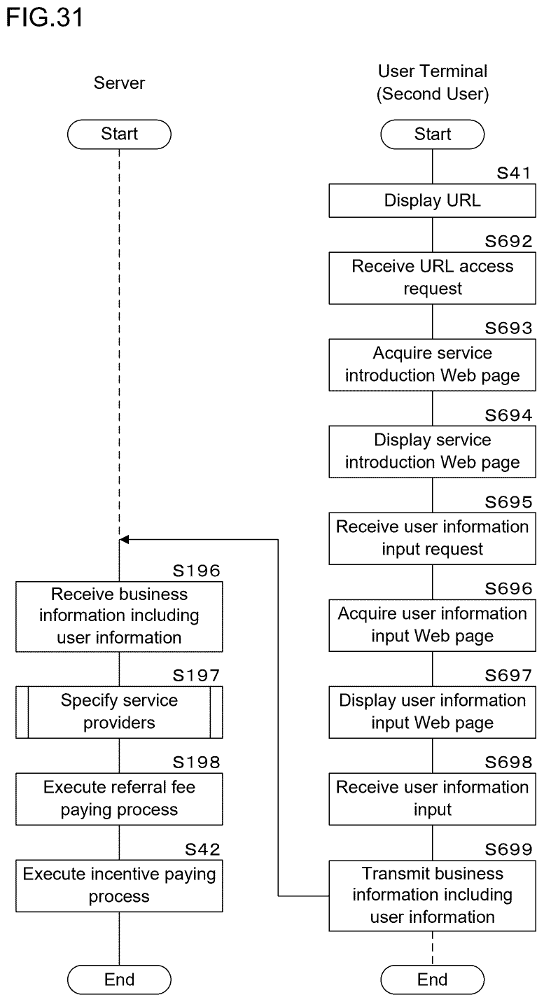

FIG. 31 is a flowchart showing the procedure of a process when executing a process of paying an incentive to a first user.

Hereinafter, the present invention will be described in detail with reference to the diagrams showing embodiments thereof.

### EMBODIMENT 1

Embodiment 1 relates to a form in which a process of paying a predetermined referral fee from a service provider specified in a single auction format to an orderer who places an order is executed. The single auction is an auction in which only one party, either the seller or the buyer, offers a price. In the present embodiment, an orderer who places an order determines the order price for the relevant order placement in advance.

Service providers include, for example, travel service providers, food and beverage service providers, and human resources or job placement service providers. In other words, a service provider may be any provider capable of placing and receiving orders. Hereinafter, an example of a service provider who provides travel services will be described, but the same can also be applied to other service providers.

FIG. 1 is an explanatory diagram showing the outline of an order placing and receiving system. The system according to the present embodiment includes an information processing device 1, an information processing terminal 2, and an information processing terminal 3, and each device transmits and receives information through a network N such as the Internet.

The information processing device 1 is an information processing device that processes, stores, and transmits and receives various kinds of information. The information processing device 1 is, for example, a server device, a personal computer, or a general-purpose tablet PC (personal computer). The information processing device 1 may be a cloud server device that provides functions as a cloud service. In the present embodiment, the information processing device 1 is assumed to be a server device, and the information processing device 1 will be read as a server 1 below for the sake of simplicity.

The information processing terminal 2 is a terminal device of a service provider (orderer) who places an order. The information processing terminal 2 is an information processing device such as a smartphone, a mobile phone, a wearable device such as an Apple Watch (registered trademark), a tablet, or a personal computer terminal. The information processing terminal 2 will be read as an orderer terminal 2 below for the sake of simplicity.

The information processing terminal 3 is a terminal device of a service provider that receives and displays business information indicating the details of business and receives orders. The information processing terminal 3 is an information processing device such as a smartphone, a mobile phone, a wearable device such as an Apple Watch, a tablet, or a personal computer terminal. The information processing terminal 3 will be read as a provider terminal 3 below for the sake of simplicity.

Currently, service providers in an area attract service users through customer attraction service systems operated by companies outside the area. However, if the service providers in the area are unable to meet the demands of the service users, there is a problem that the profit that should be gained within the area will go outside the area, including the loss of the service users.

In order to solve the above problem, when a service provider in an area is unable to meet the demands of service users, the service provider places orders with a plurality of service providers in the same area who can meet the demands of the service users, so that it is possible to prevent the outflow of service users to the outside of the area.

The server 1 according to the present embodiment registers a plurality of service providers who provide services. The server 1 acquires business information indicating the details of business from the orderer terminal 2. The server 1 transmits the acquired business information to the provider terminal 3 of each registered service provider. In relation to the business information, the server 1 specifies a service provider with whom an order for the business is to be placed, among the plurality of service providers, in a single auction format on a first-come, first-served basis. The server 1 executes a process of paying a predetermined referral fee from the specified service provider to the orderer who places an order for the business.

FIG. 2 is a block diagram showing a configuration example of the server 1. The server 1 includes a control unit 11, a storage unit 12, a communication unit 13, an input unit 14, a display unit 15, a reading unit 16, and a mass storage unit 17. The respective components are connected to each other through a bus B.

The control unit 11 includes an arithmetic processing device such as a CPU (Central Processing Unit), an MPU (Micro-Processing Unit), a GPU (Graphics Processing Unit), an FPGA (Field Programmable Gate Array), a DSP (Digital Signal Processor), or a quantum processor, and performs various kinds of information processing, control processing, and the like related to the server 1 by reading and executing a control program 1P (program product) stored in the storage unit 12.

In addition, the control program 1P can be loaded so as to run on a single computer, or can be loaded so as to run on a plurality of computers interconnected through a communication network by being located at one site or distributed across a plurality of sites. In addition, although the control unit 11 is described as a single processor in FIG. 2, the control unit 11 may be a multiprocessor.

The storage unit 12 includes memory elements such as a RAM (Random Access Memory) and a ROM (Read Only Memory), and stores the control program 1P, data, and the like necessary for the control unit 11 to execute processing. In addition, the storage unit 12 temporarily stores data and the like required for the control unit 11 to execute arithmetic processing. The communication unit 13 is a communication module for performing communication-related processing, and transmits and receives information to and from the orderer terminal 2 or the provider terminal 3 through the network N.

The input unit 14 is an input device such as a mouse, a keyboard, a touch panel, or a button, and outputs the received operation information to the control unit 11. The display unit 15 is a liquid crystal display, an organic EL (electroluminescence) display, or the like, and displays various kinds of information according to instructions from the control unit 11.

The reading unit 16 reads a portable storage medium la including a CD (Compact Disc)-ROM or a DVD (Digital Versatile Disc)-ROM. The control unit 11 may read the control program 1P from the portable storage medium la through the reading unit 16 and store the control program 1P in the mass storage unit 17. In addition, the control unit 11 may download the control program 1P from another computer through the network N or the like and store the control program 1P in the mass storage unit 17. In addition, the control unit 11 may read the control program 1P from a semiconductor memory 1b.

The mass storage unit 17 includes a recording medium such as a HDD (Hard disk drive) or an SSD (Solid State Drive). The mass storage unit 17 includes a provider DB (database) 171, a business DB 172, an order reception application DB 173, and an order placement management DB 174.

The provider DB 171 stores information about service providers who provide services. The business DB 172 stores business information indicating the details of business. The order reception application DB 173 stores information about order reception applications by service providers. The order placement management DB 174 stores management information about order placement.

In addition, in the present embodiment, the storage unit 12 and the mass storage unit 17 may be configured as an integrated storage device. In addition, the mass storage unit 17 may be configured by a plurality of storage devices. In addition, the mass storage unit 17 may be an external storage device connected to the server 1.

The server 1 may execute various kinds of information processing, control processing, and the like on a single computer, or may execute these processes in a distributed manner on a plurality of computers. In addition, the server 1 may be realized by a plurality of virtual machines installed in one server, or may be realized by using a cloud server.

FIG. 3 is an explanatory diagram showing an example of a record layout of each of the provider DB 171 and the business DB 172.

The provider DB 171 includes a provider ID column, a provider name column, an area column, a service details column, a representative column, and an employee column. The provider ID column stores IDs of uniquely specified providers in order to identify each provider. The provider name column stores the names of the providers. The area column stores areas (for example, Okinawa Prefecture) where the providers provides services. The service details column stores the details of the services provided by the providers (for example, a canoe tour).

The representative column includes a name column, an account column, and an bank account information column. The name column stores the names of the representatives of the service providers. The account column stores information about the accounts of the representatives used when logging in (for example, account IDs and passwords).

The bank account information column stores the bank account information of the representatives. The bank account information includes the bank account information of banks held by the representatives (such as the names of the banks, branch names, or account numbers) or electronic payment information (such as types of electronic payment, provider names, electronic payment numbers, account holders, or expiration date). Electronic payments include credit card payments or payments using electronic payment apps, electronic money, or transportation IC cards.

The employee column includes an employee ID column, an account column, and an bank account information column. The employee ID column stores employee IDs to identify employee. The account column stores information about the accounts of the employees used when logging in. The bank account information column stores employee bank account information.

As shown in the diagram, the provider DB 171 stores the accounts of employees of service providers in association with the accounts of the representatives of the service providers.

The business DB 172 includes a business ID column, an orderer ID column, a business information column, and a service user column. The business ID column stores IDs of uniquely specified pieces of business information in order to identify each piece of business information. With a service provider who places an order as an orderer, the orderer ID column stores an orderer ID (provider ID) for specifying the orderer.

The business information column includes an area column, a title column, a service details column, and a unit price column. The area column stores areas where services are provided. The title column stores the titles of the services. The service details column stores the details of the services (for example, a canoe tour). The unit price column stores the unit prices of the services.

The service user column includes a name column, a contact information column, a number of users column, and a notes column. The name column stores the names of users who use the services. The contact information column stores the contacts of the users. The number of users column stores the number of users using the services. The notes column stores information such as comments or supplementary information for the service users. For example, the notes column may store the user's body size, information indicating the presence or absence of a phobia and chronic illness, information indicating the presence or absence of an allergy, or, the age of the youngest or oldest user, and the like.

FIG. 4 is an explanatory diagram showing an example of a record layout of each of the order reception application DB 173 and the order placement management DB 174.

The order reception application DB 173 includes an application ID column, a business ID column, an applicant ID column, and an application date and time column. The application ID column stores IDs of uniquely specified order reception application data in order to identify order reception application data for each business. The business ID column stores business IDs for identifying business. The applicant ID column stores provider IDs of service providers who apply to receive the orders. The application date and time column stores information about the date and time when the order was applied.

The order placement management DB 174 includes a management ID column, a business ID column, an orderer ID column, a contractor ID column, a total amount column, a referral fee column, and an order date and time column. The management ID column stores IDs of uniquely specified order placement management data in order to identify order placement management data for each business.

The business ID column stores business IDs for specifying business. With a service provider who places an order as an orderer, the orderer ID column stores an orderer ID (provider ID) for specifying the orderer. With a service provider who receives an order as a contractor, the contractor ID column stores a contractor ID (provider ID) for specifying the contractor.

The total amount column stores the total amount of service usage fee. The referral fee column stores the referral fee paid from the contractor to the orderer. In addition, the referral fee will be described later. The order date and time column stores information about the date and time when the order was placed.

In addition, the storage form of each DB described above is an example, and other storage forms may be used as long as the relationship between the pieces of data is maintained.

FIGS. 5A and 5B are block diagrams showing configuration examples of the orderer terminal 2 and the provider terminal 3. FIG. 5A is a block diagram showing a configuration example of the orderer terminal 2. The orderer terminal 2 includes a control unit 21, a storage unit 22, a communication unit 23, an input unit 24, and a display unit 25. The respective components are connected to each other through the bus B.

The control unit 21 includes an arithmetic processing unit such as a CPU and an MPU, and performs various kinds of information processing, control processing, and the like related to the orderer terminal 2 by reading and executing a control program 2P (program product) stored in the storage unit 22. In addition, although the control unit 21 is described as a single processor in FIG. 5A, the control unit 21 may be a multiprocessor.

The storage unit 22 includes memory elements such as a RAM and a ROM, and stores the control program 2P, data, and the like necessary for the control unit 21 to execute processing. In addition, the storage unit 22 temporarily stores data and the like necessary for the control unit 21 to execute arithmetic processing.

The communication unit 23 is a communication module for performing processing related to communication, and transmits and receives information to and from the server 1 through the network N. The input unit 24 may be a keyboard, a mouse, or a touch panel integrated with the display unit 25. The display unit 25 is a liquid crystal display, an organic EL display, or the like, and displays various kinds of information according to instructions from the control unit 21.

FIG. 5B is a block diagram showing a configuration example of the provider terminal 3. The provider terminal 3 includes a control unit 31, a storage unit 32, a communication unit 33, an input unit 34, and a display unit 35. The respective components are connected to each other through the bus B. In addition, since the configuration of the provider terminal 3 is the same as that of the orderer terminal 2, the description thereof will be omitted.

FIG. 6 is an explanatory diagram for explaining the processing operation of the order placing and receiving system.

First, a process of registering a plurality of service providers in advance will be described. Specifically, the provider terminal 3 of each service provider receives an input of service provider information by the service provider. The service provider information includes provider names, areas where services are provided (for example, Okinawa Prefecture, Yaeyama District), details of the services (for example, a canoe tour), representative information (name, account or bank account information, and the like), or employee information of each employee (name, account or bank account information, and the like), and the like. Each provider terminal 3 transmits the received service provider information to the server 1.

The server 1 receives the service provider information transmitted from each provider terminal 3. The server 1 stores (registers) the received service provider information in the provider DB 171. Specifically, the server 1 assigns a provider ID to the received service provider information. The server 1 stores the provider name, area, details of services, representative information, and employee information of each employee in the provider DB 171 in association with the assigned provider ID. That is, the server 1 stores the account of the employee included in the employee information in association with the account of the representative included in the representative information.

Next, a process of registering business information indicating the details of business in advance will be described. Specifically, a service provider who places an order is assumed to be an orderer, and the orderer terminal 2 of the orderer receives an input of business information. The business information includes an area where services are provided, a title, details or unit price of the services, and the like. The orderer terminal 2 transmits the received business information to the server 1. The server 1 receives the business information transmitted from the orderer terminal 2.

The server 1 stores (registers) the received business information in the business DB 172. Specifically, the server 1 assigns a business ID to the received business information. The server 1 stores the area where services are provided, the title, the details and unit price of the services in the business DB 172 as one record in association with the assigned business ID.

Subsequently, a process in which a service provider applies to receive an order will be described. The server 1 acquires a plurality of service providers stored in the provider DB 171. The server 1 transmits business information, which has been transmitted from the orderer terminal 2, to the provider terminals 3 of the plurality of service providers acquired. Each provider terminal 3 receives and displays the business information transmitted from the server 1. When an application to receive the order by the service provider is received, each provider terminal 3 transmits the received order reception application information to the server 1. The order reception application information includes a provider ID, a business ID, application date and time, and the like.

The server 1 receives the order reception application information transmitted from each provider terminal 3. The server 1 stores the received order reception application information in the order reception application DB 173. Specifically, the server 1 assigns an application ID to the received order reception application information. The server 1 stores the business ID, the provider ID of the service provider who applied to receive the order, and the application date and time in the order reception application DB 173 as one record in association with the assigned application ID.

Subsequently, a process of placing an order with a service provider will be described. First, the server 1 acquires user information of users who use the services and adds the user information to the business information.

Specifically, the orderer terminal 2 acquires user information. For example, the orderer terminal 2 may receive a user's application for service use through an inquiry form, email, and the like to acquire the user information. In addition, the orderer terminal 2 may acquire the user information through a social networking service (SNS) application such as LINE (registered trademark), Twitter (registered trademark), Instagram (registered trademark), or Facebook (registered trademark). The user information includes the user's name, contact information, the number of users, notes (such as the user's body size, information indicating the presence or absence of a phobia or chronic illness), and the like.

The orderer terminal 2 calculates the total amount of service usage fee based on the unit price of the services and the number of users. For example, when the unit price for an adult is 30,000 yen and the unit price for a child is 15,000 yen, the total amount for two adults and one child is 75,000 yen. The orderer terminal 2 calculates a predetermined referral fee. The referral fee may be a predetermined amount (for example, 5,000 yen) or may be calculated as a predetermined percentage (for example, 15%) of the total amount of service usage fee. In addition, a process of calculating the total amount of service usage fee and the referral fee may be executed on the server 1 side.

The orderer terminal 2 transmits the acquired user information, the calculated total amount of service usage fee, and the referral fee to the server 1 in association with the business ID. The server 1 receives the business ID, the user information, the total amount, and the referral fee transmitted from the orderer terminal 2. The server 1 adds the received user information to the business information based on the received business ID. Specifically, the server 1 stores the user's name, contact information, the number of users, and notes in the business DB 172 in association with the business ID.

In addition, although an example in which each of the business information and the user information is registered has been described in the present embodiment, the present invention is not limited thereto. For example, the business information and the user information may be registered at the same time.

Then, the server 1 specifies a service provider with whom the order can be placed, among the registered service providers, in a single auction format on a first-come, first-served basis. Specifically, the server 1 acquires the details of the area and services (business) registered in the business information from the business DB 172 based on the business ID. The server 1 acquires the details of the area and service registered in the service provider information from the provider DB 171 based on the provider ID of each service provider.

The server 1 compares the area and the details of the services registered in the business information with the area and the details of the services registered in the service provider information. When the areas and the details of the services match completely or partially, the server 1 extracts the relevant service provider. The server 1 acquires the order reception application date and time of each service provider from the order reception application DB 173 based on the provider ID of each extracted service provider. The server 1 specifies a service provider corresponding to the earliest application date and time, among the acquired order reception application dates and times of each service provider, as a service provider with whom the order can be placed.

The server 1 places an order by transmitting the business information with the user information to the specified service provider. Specifically, the server 1 transmits the business ID, the user information, the total amount, and the referral fee to the provider terminal 3 (contractor terminal 3) of the specified service provider to execute the order placement processing.

The server 1 stores the order placement information in the order placement management DB 174. Specifically, the server 1 assigns a management ID. The server 1 stores the business ID, the orderer ID, the contractor ID, the total amount of service usage fee, the referral fee, and the order date and time in the order placement management DB 174 as one record in association with the assigned management ID.

Then, the server 1 executes a process of paying a predetermined referral fee from the specified service provider (contractor) to the orderer. The server 1 acquires the bank account information of the representative of the relevant service provider from the business DB 172 based on the orderer ID and the contractor ID. Specifically, the server 1 acquires the bank account information of the representative of the relevant service provider (orderer) from the business DB 172 based on the orderer ID. The server 1 acquires the bank account information of the representative of the relevant service provider (contractor) from the business DB 172 based on the contractor ID.

In addition, orders can be placed or received by employees designated by the representative. In this case, the server 1 receives order placement and order reception by the employee and acquires the bank account information of the employee of the relevant service provider from the business DB 172. In addition, the bank account information of the representative of the service provider may be the same as the bank account information of the employee of the service provider.

For example, when the bank account information is a bank account, the server 1 executes a process of paying (transfer) a predetermined referral fee from the bank account of the contractor to the bank account of the orderer through a banking system used by the contractor or the orderer. In addition, without being limited to using the banking system, the server 1 may execute the payment process by using an external system that provides payment services using various payment methods, such as an accounting system, a credit card system, or an electronic payment app.

However, the present invention is not limited to the referral fee payment process described above. For example, the contractor terminal 3 may pay the referral fee directly to the orderer terminal 2 by using an external system that provides payment services.

FIG. 7 is an explanatory diagram showing an example of a display screen for placing an order (making a request). The screen includes a business information display field 11a, a user information input field 11b, and a service request button 11c. The business information display field 11a is a display field for displaying business information indicating the details of business. The user information input field 11b is a field for receiving the input of user information. The service request button 11c is a button for making a request (placing an order) for the services.

The orderer terminal 2 acquires pre-registered business information from the business DB 172 of the server 1 based on the business ID. The business information includes the date, title, service details and unit price, and the like. The orderer terminal 2 displays the acquired business information in the business information display field 11a. As shown in the diagram, the date and title of the services and the details of the services (details of the request) are displayed in the business information display field 11a.

When an input operation in the user information input field 11b is received, the orderer terminal 2 acquires user information of the user who uses the services. The user information includes the representative's name, contact information (for example, telephone number and email address), the number of users, or notes (for example, information indicating the presence or absence of a phobia or chronic illness). In addition, the orderer terminal 2 may directly acquire the user information from the user's terminal device through the communication unit 23.

The orderer terminal 2 automatically calculates the total amount of service usage fee and the referral fee based on the unit price of the services included in the business information and the number of users input through the user information input field 11b. As shown in the diagram, when the unit price for an adult is 30,000 yen and the unit price for a child is 15,000 yen, the total amount for two adults and one child is 75,000 yen.

The referral fee may be calculated, for example, as a percentage of the total amount. For example, the referral fee may be calculated as 10% of the total amount, so that the higher the total amount, the higher the referral fee. As shown in the diagram, the referral fee calculated as 10% of the total amount is 7,500 yen. In addition, the referral fee may be a fixed amount (for example, 5,000 yen).

When a touch operation on the service request button 11c is received, the orderer terminal 2 transmits the received user information, the total amount, and the referral fee to the server 1 in association with the business ID. In addition, the process of calculating the total amount of service usage fee and the referral fee may be executed on the server 1 side.

FIG. 8 is a flowchart showing the procedure of a process when registering service provider information. The control unit 31 of the provider terminal 3 of each service provider receives an input of the service provider information by the service provider through the input unit 34 (step S301). The service provider information includes the provider name, the area where the services are provided (for example, Okinawa Prefecture), details of the services, representative information (name, account or bank account information, and the like), or employee information of each employee (name, account or bank account information, and the like), and the like. The control unit 31 transmits the received service provider information to the server 1 through the communication unit 33 (step S302).

The control unit 11 of the server 1 receives the service provider information transmitted from each provider terminal 3 through the communication unit 13 (step S101). The control unit 11 stores (registers) the received service provider information in the provider DB 171 in the mass storage unit 17 (step S102), and ends the process. Specifically, the control unit 11 assigns a provider ID to the received service provider information. The control unit 11 stores the provider name, area, details of services, representative information, and employee information of each employee in the provider DB 171 in association with the assigned provider ID.

FIG. 9 is a flowchart showing the procedure of a process when registering business information. The control unit 21 of the orderer terminal 2 receives an input of business information through the input unit 24 (step S211). The business information includes an area where services are provided, a title, details or unit price of the services, and the like. The control unit 21 transmits the received business information to the server 1 through the communication unit 23 (step S212).

The control unit 11 of the server 1 receives the business information transmitted from the orderer terminal 2 through the communication unit 13 (step S111). The control unit 11 stores (registers) the received business information in the business DB 172 in the mass storage unit 17 (step S112), and ends the process. Specifically, the control unit 11 assigns a business ID to the received business information. The control unit 11 stores the area where the services are provided, the title, the details and unit price of the services in the business DB 172 as one record in association with the assigned business ID.

FIG. 10 is a flowchart showing the procedure of a process when placing an order with a service provider. The control unit 21 of the orderer terminal 2 acquires user information of the user through the communication unit 23 using an inquiry form, an e-mail, or the like (step S221). The user information includes the user's name, contact information, the number of users, notes (such as information indicating the presence or absence of chronic illness), and the like.

Based on the business ID, the control unit 21 acquires the unit price of the services from the business DB 172 in the mass storage unit 17 of the server 1 through the communication unit 23 (step S222). The control unit 21 calculates the total amount of service usage fee based on the acquired unit price of the services and the number of users included in the user information (step S223).

The control unit 21 calculates a referral fee based on, for example, a predetermined percentage (for example, 10%) of the total amount (step S224). The control unit 21 transmits the acquired user information the calculated total amount and referral fee to the server 1 through the communication unit 23 (step S225).

The control unit 11 of the server 1 receives the user information, the total amount, and the referral fee transmitted from the orderer terminal 2 through the communication unit 13 (step S121). The control unit 11 adds the received user information to the business information based on the business ID (step S122). Specifically, the control unit 11 stores the name, contact information, the number of users, and notes in the business DB 172 in association with the business ID.

The control unit 11 executes a subroutine for the process of specifying service providers with whom the order can be placed (step S123). In addition, the subroutine for the process of specifying service providers will be described later. The control unit 11 transmits the business information with the user information, including the business ID, the user information, the total amount, and the referral fee, to the provider terminal 3 of the specified service provider through the communication unit 13 (step S124).

The control unit 31 of the provider terminal 3 of the relevant service provider receives the business information with the user information transmitted from the server 1 through the communication unit 33 (step S323). The control unit 31 displays the received business information with the user information on the display unit 35 (step S324), and ends the process.

The control unit 11 of the server 1 stores the order placement information in the order placement management DB 174 in the mass storage unit 17 (step S125). Specifically, the control unit 11 assigns a management ID. The control unit 11 stores the business ID, the orderer ID, the contractor ID, the total amount of service usage fee, the referral fee, and the order date and time in the order placement management DB 174 as one record in association with the assigned management ID.

The control unit 11 acquires the bank account information of the representative of the relevant service provider (orderer) from the business DB 172 in the mass storage unit 17 based on the orderer ID (step S126). The control unit 11 acquires the bank account information of the representative of the relevant service provider (contractor) from the business DB 172 in the mass storage unit 17 based on the provider ID of the specified service provider (step S127). The control unit 11 executes a process of paying the referral fee from the bank account of the contractor to the bank account of the orderer through, for example, a banking system (step S128), and ends the process.

FIG. 11 is a flowchart showing the processing procedure of a subroutine for a process of specifying service providers with whom orders can be placed. The control unit 11 acquires the area and the details of services registered in the business information from the business DB 172 in the mass storage unit 17 based on the business ID (step S01). The control unit 11 extracts, from the provider DB 171 in the mass storage unit 17, a plurality of service providers for whom areas and details of services registered in the business information completely or partially match areas and details of services registered in the service provider information (step S02).

The control unit 11 acquires the order reception application date and time of each service provider from the order reception application DB 173 in the mass storage unit 17 based on the provider ID of each extracted service provider (step S03). The control unit 11 specifies a service provider corresponding to the earliest order reception application date and time, among the acquired order reception application dates and times of the service providers, as a service provider with whom orders can be placed (step S04). The control unit 11 ends the subroutine for the process of specifying service providers and returns.

According to the present embodiment, it becomes possible to output business information to each registered service provider and specify a service provider, with whom an order is to be placed, among a plurality of service providers.

According to the present embodiment, it becomes possible to pay a predetermined referral fee from the specified service provider to the orderer who places an order.

According to the present embodiment, since the orderer place orders with service providers in the same area, it is possible to prevent the outflow of service users to the outside of the area.

### Modification Example 1

A process of receiving the settings of service providers to be blocked (excluded) from among service providers with whom orders can be placed. FIG. 12 is a flowchart showing the processing procedure of a subroutine for a process of specifying service providers with whom orders can be placed in Modification Example 1. In addition, the same contents as in FIG. 11 are denoted by the same reference numerals, and the description thereof will be omitted.

After executing the processing of step S02, the control unit 11 of the server 1 transmits service provider information (such as provider IDs or provider names) of a plurality of service providers, with whom orders can be placed, to the orderer terminal 2 through the communication unit 13 (step S11). The control unit 21 of the orderer terminal 2 receives the service provider information of the plurality of service providers transmitted from the server 1 through the communication unit 23 (step S12). The control unit 21 displays the received service provider information on the display unit 25 (step S13).

The control unit 21 receives the settings of service providers to be blocked through the input unit 24 (step S14). The control unit 21 transmits the received provider IDs of the service providers to be blocked to the server 1 through the communication unit 23 (step S15).

The control unit 11 of the server 1 receives the provider IDs of the service providers to be blocked, which are transmitted from the orderer terminal 2, through the communication unit 13 (step S16). The control unit 11 removes the service providers (service providers to be blocked) corresponding to the received provider IDs from the plurality of extracted service providers with whom orders can be placed (step S17). The control unit 11 executes the processing of step S03.

According to this modification example, it becomes possible to block a set service provider from among service providers with whom orders can be placed.

### EMBODIMENT 2

Embodiment 2 relates to a form in which a process of paying a predetermined commission from a specified service provider to a system operator is executed. In addition, the description of the same contents as in Embodiment 1 will be omitted.

FIG. 13 is an explanatory diagram showing an example of a record layout of the order placement management DB 174 in Embodiment 2. In addition, the description of the same contents as in FIG. 4 will be omitted. The order placement management DB 174 includes a commission column. The commission column stores a commission paid to the system operator by the specified service provider (contractor).

FIG. 14 is a flowchart showing the procedure of a process when paying a commission from a service provider to a system operator. The control unit 11 of the server 1 calculates a commission (a predetermined commission) to be paid from the specified service provider to the system operator (step S131). The commission may be a predetermined amount (for example, 2,000 yen), or may be calculated as a predetermined percentage (for example, 5%) of the total amount of service usage fee.

The control unit 11 stores the calculated commission in the order placement management DB 174 in the mass storage unit 17 in association with the management ID of the order placement information (step S132). The control unit 11 acquires the bank account information of the representative of the relevant service provider (contractor) from the business DB 172 in the mass storage unit 17 based on the provider ID of the specified service provider (step S133).

The control unit 11 acquires the bank account information of the system operator (step S134). For example, when the bank account information of the system operator is stored in advance in the mass storage unit 17, the control unit 11 may acquire the bank account information of the system operator from the mass storage unit 17. The control unit 11 executes a process of paying the commission from the bank account of the contractor to the bank account of the system operator through, for example, a banking system (step S135).

In addition, without being limited to using the banking system, the server 1 may execute the payment process by using an external system that provides payment services using various payment methods, such as an accounting system, a credit card system, or an electronic payment app. In addition, the provider terminal 3 may execute a process of paying a commission to the system operator by using a banking system, a payment system, and the like.

The control unit 11 transmits a message including the completion of the commission payment to the provider terminal 3 through the communication unit 13 (step S136). The control unit 31 of the provider terminal 3 receives the commission payment completion message transmitted from the server 1 through the communication unit 33 (step S331). The control unit 31 displays the received commission payment completion message on the display unit 35 (step S332), and ends the process.

In addition, although an example of the process of paying a predetermined commission from the specified service provider (contractor) to the system operator has been described in the present embodiment, the present invention is not limited thereto. For example, a predetermined commission may be paid from the orderer to the system operator, or a predetermined commission may be paid from both the orderer and the contractor to the system operator.

According to the present embodiment, it becomes possible to pay a predetermined commission from the specified service provider to the system operator.

### EMBODIMENT 3

Embodiment 3 relates to a form in which business information is output to the provider terminal 3 of each service provider belonging to the community. In addition, the description of the same contents as in Embodiments 1 and 2 will be omitted.

FIG. 15 is a block diagram showing a configuration example of the server 1 in Embodiment 3. In addition, the same contents as in FIG. 2 are denoted by the same reference numerals, and the description thereof will be omitted. The mass storage unit 17 stores a community DB 175 and a community participant DB 176. The community DB 175 stores information about the community. The community participant DB 176 stores information about a plurality of service providers (participants) included in the community.

FIG. 16 is an explanatory diagram showing an example of a record layout of each of the community DB 175 and the community participant DB 176.

The community DB 175 includes a community ID column, a community name column, an image column, a service details column, a referral fee column, a rules column, a participation conditions column, an auto-blocking column, a creator column, and a creation date and time column. The community ID column stores IDs of uniquely specified communities in order to identify each community. The community name column stores the names of the communities. The image column stores images or thumbnail images of the communities.

The service details column stores the details of services in the communities. The referral fee column stores referral fees in the communities. The rules column stores community rules to prevent trouble between participants or between participants and customers. The participation conditions column stores the conditions for participating in the community. The participation conditions may be conditions set based on, for example, the area of the service provider or the details of the services.

The auto-blocking column stores information indicating whether or not to automatically block a service provider when the service provider participating in the community is a new participant. For example, when a new participant is automatically blocked, “O” is stored in the auto-blocking column. Alternatively, when a new participant is not automatically blocked, “X” is stored in the auto-blocking column.

The creator column stores the ID or name of a creator who created the community. The creator of a community is an orderer who places an order or a contractor who receives an order. The creation date and time column stores information about the date and time when the community was created.

The community participant DB 176 includes a community ID column, a participant ID column, a blocking target column, and a column for order reception by employees. The community ID column stores community IDs for identifying communities. The participant ID column stores participant IDs (service provider IDs) of participants (service providers) participating in the communication.

The blocking target column stores information indicating whether the service provider is a blocking target or not. For example, when the service provider is a blocking target, “O” is stored in the blocking target column. Alternatively, when the service provider is not a blocking target, “X” is stored in the blocking target column.

The column for order reception by employees stores information indicating whether or not an employee of the service provider can receive an order for the business in the community. For example, when the representative of the service provider permits employees to receive orders for the business in the community, “O” is stored in the column for order reception by employees. Alternatively, when the representative of the service provider does not permit employees to receive orders, “X” is stored in the column for order reception by employees.

In addition, the storage form of each DB described above is an example, and other storage forms may be used as long as the relationship between the pieces of data is maintained.

The creator of a community is an orderer or a contractor. For the sake of simplicity, the orderer terminal 2 of the orderer or the provider terminal 3 of the contractor will be read as a creator terminal 4 below. The creator terminal 4 receives an input of community information and transmits the received community information to the server 1. The server 1 stores the community information transmitted from the creator terminal 4 in the community DB 175.

FIG. 17 is an explanatory diagram showing an example of a community creation screen. The screen includes a community information input field 12a, an auto-blocking setting field 12b, and a community creation button 12c. The community information input field 12a is a field for receiving the input of community information. The auto-blocking setting field 12b is a field for setting whether or not to automatically block a new participant. The community creation button 12c is a button for creating a community.

When an input operation in the community information input field 12a is received, the creator terminal 4 acquires the received community information. The community information includes the name of the community, an image, details of business, a referral fee, rules of the community, participation conditions, and the like.

When a setting operation in the auto-blocking setting field 12b is received, the creator terminal 4 acquires information indicating whether or not to automatically block a new participant. For example, when “accept” is selected in the auto-blocking setting field 12b, the creator terminal 4 acquires information indicating that a new participant is not automatically blocked. Alternatively, when “do not accept” is selected in the auto-blocking setting field 12b, the creator terminal 4 acquires information indicating that a new participant is automatically blocked.

When a touch operation on the community creation button 12c is received, the creator terminal 4 transmits to the server 1 the community information and the information indicating whether or not to automatically block a new participant. The server 1 stores the community information and the information indicating whether or not to automatically block a new participant, which have been transmitted from the creator terminal 4, in the community DB 175.

Specifically, the server 1 assigns a community ID, and stores the name of the community, the image, the details of business, the referral fee, the rules, the participation conditions, the information indicating whether or not to automatically block a new participant, the creator ID, and the creation date and time in the community DB 175 as one record in association with the assigned community ID.

Then, based on the details of business included in the community information, the server 1 acquires from the provider DB 171 a plurality of provider IDs of service providers who provide the same services. The server 1 transmits an invitation to participate in the community to the provider terminal 3 of each service provider acquired. The invitation may be, for example, a URL (Uniform Resource Locator) of a screen for accepting a request to participate in the community (FIG. 18), which will be described later, or explanatory information including the name of the community and the details of business.

However, the present invention is not limited to the process described above. For example, the creator terminal 4 acquires from the server 1 an invitation including the URL of a screen for accepting a request to participate in the community (FIG. 18). The creator terminal 4 may transmit the acquired invitation to the service provider through various SNS applications including a short message posting application.

The provider terminal 3 (hereinafter, referred to as a participant terminal 5) of the invited service provider receives and displays the invitation transmitted from the server 1. When a request from the participant (service provider) to participate in the community is accepted, the participant terminal 5 transmits the accepted request to the server 1. The server 1 receives a participation request transmitted from the participant terminal 5. The server 1 transmits the received participation request to the creator terminal 4 of the creator who created the community.

FIG. 18 is an explanatory diagram showing an example of a screen for receiving a request to participate in a community. The screen includes a community name display field 13a, a community information display field 13b, and a participation application button 13c. The community name display field 13a is a display field for displaying the name of the community. The community information display field 13b is a display field for displaying community information. The participation application button 13c is a button for applying to participate in the community.

The participant terminal 5 acquires the screen from the server 1 through the invitation to participate in the community (for example, the URL of the screen for receiving a participation request) and displays the screen. For example, when a touch operation on the URL of the participation request reception screen is received, the participant terminal 5 transmits a request to acquire the participation request reception screen to the server 1.

The server 1 acquires a community name, an image, details of business, a referral fee, community rules, participation conditions, or a creator from the community DB 175 based on the community ID included in the URL. The server 1 acquires the provider name (company name) of the creator (orderer or contractor) from the provider DB 171 based on the creator ID. The server 1 generates a screen for receiving a request to participate in the community based on the acquired community name, image, details of business, referral fee, community rules, participation conditions, creator, and company name.

The server 1 transmits the generated participation request reception screen to the participant terminal 5. The participant terminal 5 receives and displays the participation request reception screen transmitted from the server 1. As shown in the diagram, the name of the community is displayed in the community name display field 13a, and the community's image, details of business, referral fee, rules, participation conditions, creator, and company name are displayed in the community information display field 13b.

When a touch operation on the participation application button 13c is received, the participant terminal 5 transmits a request to participate in the community to the server 1. The participation request includes a community ID and a provider ID of a service provider who is a participant, and the like. The server 1 transmits the participation request transmitted from the participant terminal 5 to the creator terminal 4 of the creator who created the community.

The creator terminal 4 receives the participation request transmitted from the server 1. The creator terminal 4 receives the creator's decision as to whether or not to permit the participant (service provider) to participate in the community in response to the received participation request. The creator terminal 4 transmits the received information indicating permission or rejection of participation in the community to the server 1.

The server 1 receives the information indicating permission or rejection of participation transmitted from the creator terminal 4. When the creator permits the participant to participate in the community, the server 1 stores information about the participant in the community participant DB 176 in association with the community ID. Specifically, the server 1 acquires information indicating whether or not to automatically block a new participant from the community DB 175 based on the community ID. The server 1 stores the participant ID (provider ID) and information indicating whether or not the participant is a blocking target, as one record, in the community participant DB 176 in association with the community ID. For example, when a new participant is automatically blocked, the participant is a blocking target. Alternatively, when a new participant is not automatically blocked, the participant is not a blocking target.

Then, when an orderer places an order, the server 1 acquires a provider ID of each service provider belonging to the community from the community participant DB 176 based on the community ID of the community to which the orderer belongs. The server 1 outputs business information to the provider terminal 3 of the relevant service provider based on the each acquired provider ID. Thereafter, the server 1 executes a process of specifying the service provider with whom an order is to be placed and a process of paying the referral fee, similarly to the process in Embodiment 1.

FIGS. 19 and 20 are flowcharts showing the procedure of a process when receiving a request to participate in a community. In addition, although an example in which a creator is an orderer is described in FIG. 19, the same can also be applied to a contractor. The control unit 21 of the creator terminal 4 (orderer terminal 2) receives, through the input unit 24, an input of community information including the community name, image, details of business, referral fee, community rules, participation conditions, information indicating whether or not to automatically block a new participant, and creator ID (step S441). The control unit 21 transmits the received community information to the server 1 through the communication unit 23 (step S442).

The control unit 11 of the server 1 receives the community information transmitted from the creator terminal 4 through the communication unit 13 (step S141). The control unit 11 stores the received community information in the community DB 175 in the mass storage unit 17 (step S142). Specifically, the control unit 11 assigns a community ID. The control unit 11 stores the community name, image, details of business, referral fee, rules, participation conditions, information indicating whether or not to automatically block a new participant, creator ID (orderer ID), and creation date and time in the community DB 175 as one record in association with the assigned community ID.

In addition, if the above-described processes (steps S441 and S442 and steps S141 and S142) are executed once, the execution of the processes can be omitted from the next time.

The control unit 11 acquires a plurality of service providers (participants) who provide the same services from the provider DB 171 in the mass storage unit 17 based on the details of business included in the received community information (step S143). The control unit 11 generates an invitation including, for example, a URL of a screen (FIG. 18) for receiving a request to participate in the community (step S144). The control unit 11 transmits the invitation to participate in the community to the participant terminal 5 of each of the acquired participants through the communication unit 13 (step S145).

The control unit 31 of each participant terminal 5 receives the invitation transmitted from the server 1 through the communication unit 33 (step S541). The control unit 31 displays the received invitation on the display unit 35 (step S542). The control unit 31 receives a request from a participant to participate in the community through the input unit 34 (step S543). The participation request includes a community ID, a provider ID of a service provider who is a participant, and the like. The control unit 31 transmits the received participation request to the server 1 through the communication unit 33 (step S544).

The control unit 11 of the server 1 receives the participation request transmitted from the participant terminal 5 through the communication unit 13 (step S146), and transmits the received participation request to the creator terminal 4 (step S147). The control unit 21 of the creator terminal 4 receives the participation request transmitted from the server 1 through the communication unit 23 (step S443). The control unit 21 displays the received participation request on the display unit 25 (step S444).

The control unit 21 receives, through the input unit 24, the creator's decision as to whether or not to permit the participant to participate in the community (step S445). The control unit 21 transmits the received information indicating permission or rejection of participation in the community to the server 1 through the communication unit 23 (step S446). The control unit 11 of the server 1 receives the information indicating permission or rejection of participation, which is transmitted from the creator terminal 4, through the communication unit 13 (step S148).

Based on the received information indicating permission or rejection of participation, the control unit 11 determines whether or not the creator has permitted the participant to participate in the community (step S149). If the creator permits the participant to participate in the community (YES in step S149), the control unit 11 stores information about the participant in the community participant DB 176 in the mass storage unit 17 in association with the community ID (step S150).

Specifically, the control unit 11 acquires information indicating whether or not to automatically block a new participant from the community DB 175 in the mass storage unit 17 based on the community ID. The control unit 11 stores the participant ID and information indicating whether or not the participant is a blocking target in the community participant DB 176, as one record, in association with the community ID. For example, when a new participant is automatically blocked, the control unit 11 stores “O” in the blocking target column. Alternatively, when a new participant is not automatically blocked, the control unit 11 stores “X” in the blocking target column.

If the creator rejects the participation in the community (NO in step S149), the control unit 11 transmits a notification of rejection of participation in the community to the participant terminal 5 through the communication unit 13 (step S151). The control unit 31 of the participant terminal 5 receives the participation rejection notification transmitted from the server 1 through the communication unit 33 (step S545). The control unit 31 displays the received participation rejection notification on the display unit 35 (step S546), and ends the process.

FIG. 21 is a flowchart showing the processing procedure of a subroutine for a process of specifying service providers with whom orders can be placed in Embodiment 3. In addition, the same contents as in FIG. 11 are denoted by the same reference numerals, and the description thereof will be omitted. The control unit 11 of the server 1 acquires a provider ID of an orderer who placed the order from the order placement management DB 174 in the mass storage unit 17 based on a business ID (step S21). The control unit 11 specifies a community to which the orderer belongs from the community DB 175 in the mass storage unit 17 based on the acquired provider ID of the orderer (step S22).

The control unit 11 acquires a plurality of service providers, who belong to the community and are not blocking targets, based on the community ID of the specified community (step S23). Specifically, the control unit 11 acquires all service providers (participants) whose blocking targets are “X” based on the community ID. Thereafter, the control unit 11 executes the processing of step S01.

The control unit 11 extracts, from the plurality of service providers acquired in the processing of step S23, a plurality of service providers for whom areas and details of services registered in the business information completely or partially match areas and details of services registered in the service provider information (step S24). Thereafter, the control unit 11 executes the processing of step S03.

Subsequently, a process of receiving an order by an employee of a service provider for business in a community permitted by the representative of the service provider will be described.

FIG. 22 is a flowchart showing the procedure of a process when receiving an order by an employee. The control unit 31 of the provider terminal 3 acquires the community ID from the community DB 175 in the mass storage unit 17 of the server 1 through the communication unit 33 (step S361). The control unit 31 receives an input of permission information indicating whether or not the employee of the service provider is permitted to receive an order, from the representative of a service provider, through the input unit 34 for business in the community corresponding to the acquired community ID (step S362).

The control unit 31 transmits the received permission information to the server 1 through the communication unit 33 in association with the community ID and the provider ID (step S363). The control unit 11 of the server 1 receives the community ID, the provider ID, and the permission information transmitted from the provider terminal 3 through the communication unit 13 (step S161). The control unit 11 stores the permission information in the column for order reception by employees of the community participant DB 176 in the mass storage unit 17 in association with the received community ID and the provider ID (step S162).

In addition, if the above-described processes (steps S361 to S363 and steps S161 and S162) are executed once, the execution of the processes can be omitted from the next time.

The control unit 11 transmits the business information with the user information to the provider terminal 3 of the service provider, with whom an order is to be placed, through the communication unit 13 (step S163). The control unit 31 of the provider terminal 3 receives the business information with the user information transmitted from the server 1 through the communication unit 33 (step S364).

The control unit 31 determines whether or not the employee can receive an order (step S365). Specifically, the control unit 31 acquires permission information indicating whether or not the employee is permitted to receive an order, from the community participant DB 176 in the mass storage unit 17 of the server 1, based on the community ID and the provider ID. The control unit 31 may determine whether or not the employee is permitted to receive an order based on the acquired permission information.

When it is determined that the employee can receive an order (YES in step S365), the control unit 31 receives order reception by the employee (step S366), and ends the process. For example, the control unit 31 acquires the currently logged-in account. The control unit 31 compares the acquired account with the account of the employee stored in the provider DB 171 based on the provider ID. When the currently logged-in account is the account of the employee of the service provider, the control unit 31 receives the order reception.

When it is determined that the employee cannot receive an order (NO in step S365), the control unit 31 receives order reception by the representative (step S367), and ends the process. For example, the control unit 31 acquires the currently logged-in account. The control unit 31 compares the acquired account with the account of the representative stored in the service DB 171 based on the provider ID. When the currently logged-in account is the account of the representative of the service provider, the control unit 31 receives the order reception.

According to the present embodiment, it becomes possible to create a community including service providers who provide the same services.

According to the present embodiment, it becomes possible to output business information to the provider terminal 3 (participant terminal 5) of each service provider belonging to the community.

According to the present embodiment, it becomes possible to receive the setting of a referral fee in the community by the creator of the community.

According to the present embodiment, it becomes possible to receive, from the creator of the community, information indicating permission or rejection of the service provider's participation in the community.

According to the present embodiment, for the business in the community permitted by the representative of the service provider, the employee of the service provider can receive an order.

### EMBODIMENT 4

Embodiment 4 relates to a form in which the settings of service providers to be blocked are received in the community. In addition, the description of the same contents as in Embodiments 1 to 3 will be omitted.

FIG. 23 is a flowchart showing the procedure of a process when receiving the settings of service providers to be blocked. The control unit 21 of the orderer terminal 2 transmits a community ID to the server 1 through the communication unit 23 (step S271). The control unit 11 of the server 1 receives the community ID transmitted from the orderer terminal 2 through the communication unit 13 (step S171).

The control unit 11 acquires a plurality of service providers belonging to the community from the community participant DB 176 in the mass storage unit 17 based on the received community ID (step S172). The control unit 11 transmits service provider information (such as provider IDs or provider names) of the plurality of acquired service providers to the orderer terminal 2 through the communication unit 13 (step S173). The control unit 21 of the orderer terminal 2 receives the service provider information of the plurality of service providers transmitted from the server 1 through the communication unit 23 (step S272).

The control unit 21 displays the received service provider information of the plurality of service providers on the display unit 25 (step S273). The control unit 21 receives, through the input unit 24, the settings of service providers to be blocked in the community (step S274). The control unit 21 transmits the received provider IDs of the service providers to be blocked, in association with the community ID, to the server 1 through the communication unit 23 (step S275).

The control unit 11 of the server 1 receives the community ID and the provider IDs transmitted from the orderer terminal 2 through the communication unit 13 (step S174). The control unit 11 stores information indicating that the service provider is to be blocked (for example, “O”) in the blocking target column of the community participant DB 176 in the mass storage unit 17 in association with the received community ID and provider IDs (step S175), and ends the process.

According to the present embodiment, it becomes possible to receive the settings of service providers to be blocked in a community.

### EMBODIMENT 5

Embodiment 5 relates to a form in which, when a service provider is a new participant, the service provider is automatically blocked. In addition, the description of the same contents as in Embodiments 1 to 4 will be omitted. Blocked service providers are excluded from service providers with whom orders can be placed. In addition, shared information such as business information or event information on this order placing and receiving system may be set not to be shared with blocked service providers.

FIG. 24 is an explanatory diagram showing an example of a record layout of the provider DB 171 in Embodiment 5. In addition, the description of the same contents as in FIG. 3 will be omitted. A provider DB 171 includes an auto-blocking column.

The auto-blocking column stores information indicating whether or not to automatically block a service provider. In the present embodiment, when a service provider participating in the use of the order placing and receiving system is a new participant, the service provider is automatically blocked. For example, when the service provider is a new participant, “O” is stored in the auto-blocking column. Alternatively, when the service provider is not a new participant, “X” is stored in the auto-blocking column.

FIG. 25 is a flowchart showing the procedure of a process when registering service provider information in Embodiment 5. The control unit 31 of the provider terminal 3 of each service provider receives an input of service provider information by the service provider through the input unit 34 (step S381). The service provider information includes a provider name, an area where services are provided (for example, Okinawa Prefecture), details of the services, representative information (name, account or bank account information, and the like), or employee information of each employee (name, account or bank account information, and the like), and the like.

The control unit 31 receives, through the input unit 34, an input of information indicating that the service provider is a new participant (step S382). The control unit 31 transmits the received service provider information and information indicating that the service provider is a new participant to the server 1 through the communication unit 33 (step S383). The control unit 11 of the server 1 receives the service provider information and the information indicating that the service provider is a new participant, which are transmitted from each provider terminal 3, through the communication unit 13 (step S181).

The control unit 11 stores the received service provider information and information indicating that the service provider is a new participant in the provider DB 171 in the mass storage unit 17 (step S182), and ends the process. Specifically, the control unit 11 assigns a provider ID to the received service provider information. The control unit 11 stores the provider name, area, details of services, representative information, employee information of each employee, and the information indicating that the service provider is a new participant (for example, “O”) in the provider DB 171 in association with the assigned provider ID.

In addition, the timing for unblocking the automatically blocked service provider is set by the system operator of the order placing and receiving system, and the like. For example, after a predetermined period of time (for example, three months) has passed, the server 1 executes a process of unblocking the service provider. Specifically, the server 1 stores information indicating that the service provider is not a new participant (for example, “X”) in the provider DB 171 in association with the provider ID.

However, the present invention is not limited to a predetermined period of time. For example, when an application for unblocking is received from a service provider, the server 1 receives unblocking consent information from the system operator or the like. The server 1 may execute the unblocking process according to the received unblocking consent information.

According to the present embodiment, when the service provider is a new participant, it is possible to automatically block the service provider.

### EMBODIMENT 6

Embodiment 6 relates to a form in which a user who desires to use the services provided by a first service provider is introduced to each target service provider. In addition, the description of the same contents as in Embodiments 1 to 5 will be omitted.

There may be a case where the services provided by the first service provider, among the service providers who have registered their business information, cannot be provided to a user (person who desires to use the services) due to the usage status of accommodation facilities or the status of tour applications, and the like. In this case, the first service provider can solve the above-described problem by introducing the user who desires to use the services to each target service provider.

The system according to the present embodiment further includes an information processing terminal 6. The information processing terminal 6 is a user's terminal device that receives and displays a Web page that introduce services and receives and transmits user information. The information processing terminal 6 is an information processing device such as a smartphone, a mobile phone, a wearable device such as an Apple Watch, a tablet, or a personal computer terminal. The information processing terminal 6 will be read as a user terminal 6 below for the sake of simplicity.

FIG. 26 is a block diagram showing a configuration example of the user terminal 6. The user terminal 6 includes a control unit 61, a storage unit 62, a communication unit 63, an input unit 64, and a display unit 65. The respective components are connected to each other through a bus B. In addition, since the configuration of the user terminal 6 is similar to that of the orderer terminal 2, the description thereof will be omitted.

Subsequently, a process of introducing a user who desires to use the services provided by the first service provider to each service provider will be described.

When the services provided by the first service provider cannot be provided to a user who desires to use the services, the provider terminal 3 of the first service provider transmits to the server 1 business information to be posted on a service introduction Web page that introduces the services provided by the first service provider. The business information includes the area where the services are provided, title, details of the business (such as a service period and the required time), price (unit price), what is included in the price, target age, participation conditions, cancellation policy, what to bring, or recommended clothing, and the like.

The business information is transmitted to the server 1, for example, through a business information input Web page (not shown). A business information input Web page is a Web page prepared by the system operator or the like and including business information to be input. Specifically, the provider terminal 3 acquires the business information input Web page from the server 1. The provider terminal 3 receives an input of business information by the provider through the acquired business information input Web page. The provider terminal 3 transmits the received business information to the server 1.

In addition, the business information can be transmitted to the server 1 using a format file for inputting business information. The format file is prepared, for example, by the system operator or the like, and stored in the storage unit 12 or the mass storage unit 17 of the server 1. The format is a file including business information to be input, and any file format formed by data such as PDF (Portable Document Format), Word (registered trademark), or Excel (registered trademark) is included, but the present invention is not limited thereto.

For example, the provider terminal 3 acquires a format file for inputting business information from the server 1. The provider terminal 3 receives an input of business information by the provider through the acquired format file. The provider terminal 3 may transmit a format file including the input business information to the server 1.

The server 1 receives the business information transmitted from the provider terminal 3. The server 1 writes the received business information in a service introduction Web page (see FIG. 27 described later) that introduces the services provided by the first service provider. The server 1 issues (generates) a URL to access the service introduction Web page in which the business information is written. The server 1 transmits the issued URL to the user terminal 6 of the user. The user terminal 6 receives the URL transmitted from the server 1 and displays the received URL on the screen.

When a request for access to the received URL is received, the user terminal 6 acquires the service introduction Web page posted on the site of the server 1 specified by the URL. The user terminal 6 displays the acquired service introduction Web page.

In addition, the server 1 may generate a one-dimensional code or a two-dimensional code including a URL for accessing the service introduction Web page. For example, the server 1 generates a two-dimensional code (for example, a QR code (registered trademark)) including a URL and transmits the generated two-dimensional code to the user terminal 6. The user terminal 6 may acquire the URL for accessing the service introduction Web page by reading the two-dimensional code transmitted from the server 1.

In addition, a printed two-dimensional code may be provided in the facility of the first service provider. In this case, the user terminal 6 acquires the URL for accessing the service introduction Web page by reading the two-dimensional code provided in the facility.

The service introduction Web page includes business information about the services. The business information includes the area where the services are provided, title, details of the business (such as a service period and the required time), price (unit price), what is included in the price, target age, participation conditions, cancellation policy, what to bring, or recommended clothing, and the like. The user terminal 6 displays the acquired service introduction Web page.

When a request for input of user information is received from the user through the service introduction Web page, the user terminal 6 transitions to a user information input Web page (FIG. 28 described later) that receives an input of user information.

The user terminal 6 receives the input of user information by the user through the user information input Web page. The user information includes the name of the user (for example, representative), contact information (telephone number, email address, and the like), the number of users, accommodation before and after participation, user attributes (for example, height, weight, or shoe size), or notes (information indicating the presence or absence of phobias or chronic illnesses and the like), and the like.

The user terminal 6 transmits business information including the received user information to the server 1. The server 1 receives the business information including the user information transmitted from the user terminal 6. In relation to the received provider information, the server 1 specifies a service provider with whom an order for the services (business) is to be placed, among the registered service providers, in a single auction format on a first-come, first-served basis. The server 1 executes a process of paying a predetermined referral fee from the specified service provider to the orderer (first service provider) who places an order for the services.

In addition, since the process of specifying a service provider with whom an order is to be placed and the process of paying a referral fee are the same as those in Embodiment 1, the description thereof will be omitted.

In addition, the process of specifying a service provider is not limited to the process of specifying a service provider corresponding to the earliest application date and time as a service provider with whom an order can be placed (not limited to specifying in a single auction format on a first-come, first-served basis). As an example, a service provider with whom an order can be placed can be specified based on the order price offered to receive the order by each provider. For example, a service provider offering the highest order price may be specified as a service provider with whom an order can be placed.

FIG. 27 is an explanatory diagram showing an example of a service introduction Web page (screen). The screen includes a details display field 14a and an input screen transition button 14b. The details display field 14a is a display field for displaying the details of the services. The input screen transition button (proceeding to participant information input) 14b is a button for transitioning to the user information input Web page.

When a request for access to the URL of the service introduction Web page transmitted from the server 1 is received, the user terminal 6 acquires the service introduction Web page posted on the site of the server 1 specified by the URL. The user terminal 6 displays the acquired Web page on the screen.

As shown in the diagram, business information for services, including the service title, image, product overview, price (unit price), what is included in the price, service period, required time, target age, participation conditions, cancellation policy, what to bring, or recommended clothing, and the like, is displayed in the details display field 14a. In addition, without being limited to the items described above, other items (such as meeting place, meeting time, experience schedule, or payment method) may be included depending on actual needs.

When a touch operation on the input screen transition button 14b is received, the user terminal 6 transitions to a user information input Web page (FIG. 28 described later) that receives an input of user information.

FIG. 28 is an explanatory diagram showing an example of a user information input Web page (screen). The screen includes a user information reception field 15a and an application button 15b. The user information reception field 15a is a reception field for receiving the input of user information. The application button (application with the details described above) 15b is a button for receiving an application by a user to use the services.

When an input operation in the user information reception field 15a is received, the user terminal 6 receives an input of user information by the user. As shown in the diagram, the user terminal 6 receives an input of the number of users (the number of adults and the number of children), total participation fee, participation date, representative's name, mobile phone number, email address, accommodation before and after participation, user attributes (for example, height, weight, or shoe size), notes (information indicating the presence or absence of phobias or chronic illnesses, and the like), and the like.

In addition, the total participation fee may be automatically calculated by “adult unit price x the number of users+child unit price x the number of users”. In addition, without being limited to the items described above, an input of other items (such as gender, date of birth, and payment method) may be received depending on actual needs.

When a touch operation on the application button 15b is received, the user terminal 6 transmits business information including the received user information to the server 1.

FIG. 29 is a flowchart showing the procedure of a process when introducing a user to each service provider. The control unit 11 of the server 1 transmits a business information input Web page to the provider terminal 3 of the first service provider through the communication unit 13 (step S191). The control unit 31 of the provider terminal 3 of the first service provider receives the business information input Web page transmitted from the server 1 through the communication unit 33 (step S391).

The control unit 31 displays the received business information input Web page on the display unit 35 (step S392). The control unit 31 receives an input of business information by the provider through the input unit 34 (step S393). The control unit 31 transmits the received business information to the server 1 through the communication unit 33 (step S394).

The control unit 11 of the server 1 receives the business information transmitted from the provider terminal 3 through the communication unit 13 (step S192). The control unit 11 writes the received business information in a service introduction Web page (step S193). The control unit 11 issues (generates) a URL to access the service introduction Web page in which the business information is written (step S194).

The control unit 11 transmits the issued URL to the user terminal 6 through the communication unit 13 (step S195). The control unit 61 of the user terminal 6 receives the URL transmitted from the server 1 through the communication unit 63 (step S691). The control unit 61 receives a request for access to the received URL through the input unit 64 (step S692).

The control unit 61 acquires, through the communication unit 63, a service introduction Web page posted on the site of the server 1 specified by the URL (step S693). The service introduction Web page includes business information for the services, such as the area where the services are provided, title, and details of the services. The control unit 61 displays the acquired service introduction Web page on the display unit 65 (step S694).

Through the service introduction Web page, the control unit 61 receives a request for input of user information from the user through the input unit 64 (step S695). In response to the received user information input request, the control unit 61 acquires a user information input Web page for receiving the input of user information from the server 1 through the communication unit 63 (step S696).

The control unit 61 displays the acquired user information input Web page on the display unit 65 (step S697). Through the user information input Web page, the control unit 61 receives an input of user information (representative's name, mobile phone number, email address, the number of users, and the like) by the user through the input unit 64 (step S698).

The control unit 61 transmits business information including the received user information to the server 1 through the communication unit 63 (step S699). The control unit 11 of the server 1 receives the business information including the user information transmitted from the user terminal 6 through the communication unit 13 (step S196). The control unit 11 executes a subroutine for the process of specifying service providers with whom the order can be placed (step S197).

The control unit 11 executes a process of paying a referral fee from the bank account of the contractor to the bank account of the orderer (step S198), and ends the process. In addition, since the process of paying the referral fee is the same as that in steps S124 to S128 of FIG. 10, the description thereof will be omitted.

According to the present embodiment, it is possible to introduce a user who desires to use the services provided by the first service provider to each target service provider.

### EMBODIMENT 7

Embodiment 7 relates to a form in which, when a first user who has used services provided by a service provider introduces the services to a second user through an SNS, a process of paying a predetermined incentive from the service provider to the first user is executed. In addition, the description of the same contents as in Embodiments 1 to 6 will be omitted.

Examples of the SNS include Twitter, Facebook, Instagram, YouTube (registered trademark), and TikTok (registered trademark). In addition, although the examples of the SNS have been described in the present embodiment, the present invention is not limited thereto. Various means of communication that can be transmitted electronically, such as e-mail, short message or fax, can be used.

The server 1 issues, to the user terminal 6 of the first user who has used the services provided by the service provider, a URL for accessing a service introduction Web page that introduces the services. The user terminal 6 of the first user will be read as a user terminal 6a below for the sake of simplicity.

The user terminal 6a posts the issued URL to the SNS account of the first user through the SNS. The first user posts on the SNS a URL for accessing the service introduction Web page together with information of impressions of using the services, reviews, descriptions of the services, price, advantages, and the like, thereby spreading these to the second user. The second user includes not only a user who follows the first user but also a user who does not follow the first user.

The user terminal 6 of the second user acquires the service introduction Web page (FIG. 27) from the server 1 according to the access to the URL posted on the SNS account of the first use. The user terminal 6 of the second user will be read as a user terminal 6b below for the sake of simplicity.

The user terminal 6b displays the acquired service introduction Web page on the screen. When a request for input of user information is received from the second user through the service introduction Web page, the user terminal 6b acquires a user information input Web page (FIG. 28) for receiving the input of user information from the server 1. The user terminal 6b transitions to the acquired user information input Web page.

The user terminal 6b receives the input of user information by the second user through the user information input Web page. In addition, since the user information is the same as in Embodiment 6, the description thereof will be omitted. The user terminal 6b transmits business information including the received user information of the second user to the server 1.

The server 1 receives the business information including the user information of the second user transmitted from the user terminal 6b. In relation to the received provider information, the server 1 specifies a service provider with whom an order for the services is to be placed, among the registered service providers, in a single auction format on a first-come, first-served basis. The server 1 executes a process of paying a predetermined referral fee from the specified service provider to the orderer who places an order for the services.

The server 1 executes a process of paying a predetermined incentive from the specified service provider to the first user who introduced the second user. Incentives are stimuli to improve motivation or achieve goals, and include, for example, point rewards, legal tender, giveaways, coupons, vouchers, discount coupons, gift certificates, and virtual currencies (crypto assets).

For example, the server 1 may execute a process of paying a predetermined number of points (for example, 1,000 points) from a specified service provider to the first user by using an external system that provides points-granting services.

Alternatively, the server 1 may execute a process of paying a predetermined legal tender (for example, 1,000 yen) from the bank account of the specified service provider to the bank account of the first user by using an external system that provides payment services using various payment methods, such as a banking system, an accounting system, a credit card system, and an electronic payment app.

FIG. 30 is a flowchart showing the procedure of a process when issuing a URL to access a service introduction Web page. The control unit 31 of the provider terminal 3 transmits a business ID specifying the services to the server 1 through the communication unit 33 (step S31). The control unit 11 of the server 1 receives the business ID transmitted from the provider terminal 3 through the communication unit 13 (step S32).

Based on the received business ID, the control unit 11 specifies a first user who has already used the services from the business DB 172 in the mass storage unit 17 (step S33). The control unit 11 issues (generates) a URL for accessing the service introduction Web page (step S34). The control unit 11 transmits the issued URL to the user terminal 6a of the specified first user through the communication unit 13 (step S35).

The control unit 61 of the user terminal 6a receives the URL transmitted from the server 1 through the communication unit 63 (step S36). The control unit 61 transmits the URL to an external information processing device that provides an SNS through the communication unit 63, thereby posting the URL on the SNS (step S37). The control unit 61 ends the process.

In addition, the control unit 61 may post the URL on the SNS together with information of impressions of using the services, reviews, descriptions of the services, price, advantages, and the like.

FIG. 31 is a flowchart showing the procedure of a process when executing a process of paying an incentive to the first user. In addition, the same contents as in FIG. 29 are denoted by the same reference numerals, and the description thereof will be omitted.

The control unit 61 of the user terminal 6b of the second user displays a URL for accessing a service introduction Web page posted by the SNS account of the first user, on the display unit 65, through the SNS (step S41). The control unit 61 executes the processing of step S692.

After executing the processing of step S198, the control unit 11 of the server 1 executes a process of paying a predetermined incentive (for example, 1,000 points) from the specified service provider to the first user who introduced the second user (step S42). The control unit 11 ends the process.

According to the present embodiment, when the first user who has used the services provided by the service provider introduces the services to the second user through the SNS, it becomes possible to executes a process of paying a predetermined incentive from the service provider to the first user.

It should be considered that the embodiments disclosed herein are examples in all points and not restrictive. The scope of the present invention is defined by the claims rather than the meanings set forth above, and is intended to include all modifications within the scope and meaning equivalent to the claims.

The features described in the respective embodiments can be combined with each other. In addition, the independent claims and the dependent claims described in the claims can be combined with each other in all combinations, regardless of the citation form. In addition, although the form in which a claim cites two or more other claims (multi-claim form) is used in the claims, the present invention is not limited thereto. A form of multi-claim (multi-multi claim) that cites at least one multi-claim may also be written.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-13. (canceled)

14. An information processing method, comprising:
registering a plurality of service providers who provide services;
outputting business information indicating details of business to a terminal device of each registered service provider;
specifying, in relation to the business information, a service provider with whom an order for the business is to be placed, among the service providers, in a single auction format on a first-come, first-served basis; and
executing a process for paying a predetermined referral fee from the specified service provider to an orderer who places an order for the business.

15. The information processing method according to claim 14,
wherein an area where each service provider provides services and details of the services are registered as service provider information.

16. The information processing method according to claim 14,
wherein the business information is registered in advance,
user information of a user who uses the services is acquired, the acquired user information is added to the business information, and
an order for the business is placed with the specified service provider based on business information after the user information is added.

17. The information processing method according to claim 15,
wherein service providers with whom orders can be placed are specified based on an area and service details registered in the business information and an area and service details registered in the service provider information, and
the specified service providers with whom orders can be placed are output.

18. The information processing method according to claim 17,
wherein settings of a service provider to be blocked, among the service providers with whom orders can be placed, are received, and
the received service provider is blocked.

19. The information processing method according to claim 14,
wherein a process for paying a predetermined commission from the specified service provider to a system operator.

20. The information processing method according to claim 14,
wherein an account of an employee of the service provider is stored in association with an account of a representative of the service provider.

21. The information processing method according to claim 14,
wherein, when the service provider is a new participant, the service provider is automatically blocked.

22. The information processing method according to claim 14,
wherein a Web page introducing services is output to a user terminal,
business information including user information corresponding to the services input through the user terminal is acquired, and
the acquired business information is output to a terminal device of each registered service provider.

23. The information processing method according to claim 22,
wherein a URL (Uniform Resource Locator) for accessing a Web page introducing services provided by a first service provider among the registered service providers is set,
the Web page introducing the services of the first service provider is output to a user terminal in response to access to the URL,
business information including user information corresponding to the services input through the user terminal is acquired, and
a process for paying a predetermined referral fee from the specified service provider to the first service provider is executed.

24. The information processing method according to claim 22,
wherein a URL for accessing a Web page, which is posted on an SNS (Social Networking Service) of a first user who has used services and which introduces the services that have been used, is set,
the Web page introducing the services is output to a user terminal of a second user in response to access to the URL,
business information including user information corresponding to the services input through the user terminal is acquired, and
a process for paying a predetermined incentive from the specified service provider to the first user is executed.

25. A non-transitory computer-readable storage medium storing a program that causes a computer to execute processing of:
registering a plurality of service providers who provide services;
outputting business information indicating details of business to a terminal device of each registered service provider;
specifying, in relation to the business information, a service provider with whom an order for the business is to be placed, among the service providers, in a single auction format on a first-come, first-served basis; and
executing a process for paying a predetermined referral fee from the specified service provider to an orderer who places an order for the business.

26. An information processing device, comprising:
one or more processing devices; and
one or more storage devices storing instructions for causing the one or more processing devices executing the following processing of:
registering a plurality of service providers who provide services,
outputting business information indicating details of business to a terminal device of each registered service provider,
specifying, in relation to the business information, a service provider with whom an order for the business is to be placed, among the service providers, in a single auction format on a first-come, first-served basis, and
executing a process for paying a predetermined referral fee from the specified service provider to an orderer who places an order for the business.
